(19) United States
(12) Patent Application Publication
(10) Pub. No.: US 2016/0147044 A1
(43) Pub. Date: May 26, 2016

(54) IMAGING LENS AND IMAGING APPARATUS EQUIPPED WITH THE IMAGING LENS

(71) Applicant: FUJIFILM Corporation, Tokyo (JP)

(72) Inventor: Masato KONDO, Saitama-ken (JP)

(73) Assignee: FUJIFILM Corporation, Tokyo (JP)

(21) Appl. No.: 14/945,446

(22) Filed: Nov. 19, 2015

(30) Foreign Application Priority Data
Nov. 25, 2014 (JP) 2014-237562

(51) Int. Cl. G02B 13/00; G02B 9/62; G02B 27/00

(52) U.S. Cl. CPC G02B 13/0045; G02B 27/0025; G02B 9/62

(57) ABSTRACT

An imaging lens consisting essentially of six lenses, composed of, in order from the object side, a first lens having a negative refractive power with a concave surface on the object side, a second lens having a positive refractive power, a third lens, a fourth lens having a meniscus shape with a concave surface on the object side, a fifth lens having a meniscus shape with a concave surface on the object side, and a sixth lens having a meniscus shape with a convex surface on the object side.

### CROSS-REFERENCE TO RELATED APPLICATIONS

The present application claims priority under 35 U.S.C. §119 to Japanese Patent Application No. 2014-237562 filed on Nov. 25, 2014. The above application is hereby expressly incorporated by reference, in its entirety, into the present application.

### BACKGROUND

The present disclosure relates to a fixed-focus imaging lens that forms an optical image of a subject on an image sensor such as, for example, a charge coupled device (CCD) or a complementary metal oxide semiconductor (CMOS), and an imaging apparatus equipped with the imaging lens to perform imaging, such as a digital still camera, a camera equipped cell phone, a personal digital assistance (PDA), a smartphone, a tablet terminal, a portable game machine, or the like.

Along with a widespread use of personal computers in homes, digital still cameras capable of inputting image information, such as captured landscapes and portraits, to personal computers are spreading rapidly. In addition, more and more cell phones, smartphones, and tablet terminals are equipped with camera modules for inputting images. Such devices having imaging capabilities use image sensors, such as CCDs, CMOSs, and the like. Recently, as downsizing of these image sensors have advanced, imaging devices as a whole and imaging lenses to be equipped therein are also demanded to be downsized. At the same time, a higher pixelation of image sensors is also in progress, and high resolution and high performance are demanded for imaging lenses. For example, performance compatible with 5 mega pixels or greater, more preferably, 8 mega pixels or greater is demanded.

Imaging lenses composed of a relatively large number of lenses, i.e., five lenses or more are proposed to satisfy such demands. For example, Chinese Patent Application Publication No. 103777329 and International Patent Publication No. 2014/013676 propose imaging lenses having more lenses, i.e., six lenses, for higher performance.

### SUMMARY

In the meantime, for an imaging lens with a relatively short overall lens length used, in particular, for portable terminals, smartphones, or tablet terminals, a demand is growing for increasing the angle of view with a growing demand for a small F-number so as to be compatible with an image sensor that satisfies a demand for a higher pixelation. Preferably, the imaging lenses described in Chinese Patent Application Publication No. 103777329 and International Patent Publication No. 2014/013676 realize a smaller F-number to respond to these demands.

The present disclosure has been developed in view of the circumstances described above, and the present disclosure provides an imaging lens capable of realizing high imaging performance from the central angle of view to the peripheral angle of view in which an increase in the angle of view and a small F-number are achieved, and an imaging apparatus capable of capturing a high resolution image by equipping the imaging lens.

An imaging lens of the present disclosure consists of six lenses, composed of, in order from the object side, a first lens having a negative refractive power with a concave surface on the object side, a second lens having a positive refractive power, a third lens, a fourth lens having a meniscus shape with a concave surface on the object side, a fifth lens having a meniscus shape with a concave surface on the object side, and a sixth lens having a meniscus shape with a convex surface on the object side.

In the imaging lens of the present disclosure, the term “consists of six lenses” refers to include the case in which that the imaging lens of the present disclosure includes a lens having substantially no refractive power, an optical element other than a lens, such as a stop, a cover glass, and the like, a lens flange, a lens barrel, an image sensor, and a mechanical component, for example, a camera shake correction mechanism, other than the six lenses. The surface shapes and the signs of refractive powers of the foregoing lenses are considered in the paraxial region if an aspherical surface is involved.

Employment of the following preferable configurations in the imaging lens of the present disclosure may further improve the optical performance.

In the imaging lens of the present disclosure, the second lens preferably has a biconvex shape.

In the imaging lens of the present disclosure, the fourth lens preferably has a negative refractive power.

In the imaging lens of the present disclosure, the fifth lens preferably has a positive refractive power.

The imaging lens of the present disclosure may satisfy any one or any combination of the following conditional expressions (1) to (8) and (1-1) to (7-1).

TTL/f<3 (1)

TTL/f<2.5 (1-1)

−2<f/f1<0 (2)

−1.5<f/f1<−0.05 (2-1)

0<f/f2<3 (3)

0.5<f/f2<2.5 (3-1)

0.95<f/f3<0.95 (4)

0.85<f/f3<0.85(4-1)

2<f/f4<0 (5)

1.5<f/f4<0 (5-1)

0<f/f5<2 (6)

0<f/f5<1.5 (6-1)

1<f/L6r<4 (7)

1<f/L6r<3.5 (7-1)

1<(L4r+L40/(L4r−L4f)<10 (8)

where:

TTL is the distance from the object side surface of the first lens to the image plane on the optical axis when an air equivalent length is used for the back focus;

f is the focal length of the entire system;

f1 is the focal length of the first lens;

f2 is the focal length of the second lens;

f3 is the focal length of the third lens;

f4 is the focal length of the fourth lens;

f5 is the focal length of the fifth lens;

L6r is the paraxial radius of curvature of the image side surface of the sixth lens;

L4f is the paraxial radius of curvature of the object side surface of the fourth lens; and

L4r is the paraxial radius of curvature of the image side surface of the fourth lens.

An imaging apparatus according to the present disclosure is equipped with the imaging lens of the present disclosure.

According to the imaging lens of the present disclosure, the configuration of each lens element is optimized in a lens configuration of six elements in total. This allows realization of a lens system having high imaging performance from the central angle of view to the peripheral angle of view that satisfies the demand for a higher pixelation in which a wide angle of view and a small F-number are achieved.

According to the imaging apparatus of the present disclosure, a high resolution image may be captured because the apparatus is configured to output an imaging signal according to an optical image formed by any of the high performance imaging lenses of the present disclosure.

### BRIEF DESCRIPTION OF THE DRAWINGS

FIG. 1 is a cross-sectional view of an imaging lens according to one embodiment of the present disclosure, illustrating a first configuration example, which corresponds to Example 1.

FIG. 2 is a cross-sectional view of an imaging lens according to one embodiment of the present disclosure, illustrating a second configuration example, which corresponds to Example 2.

FIG. 3 is a cross-sectional view of an imaging lens according to one embodiment of the present disclosure, illustrating a third configuration example, which corresponds to Example 3.

FIG. 4 is a cross-sectional view of an imaging lens according to one embodiment of the present disclosure, illustrating a fourth configuration example, which corresponds to Example 4.

FIG. 5 is a cross-sectional view of an imaging lens according to one embodiment of the present disclosure, illustrating a fifth configuration example, which corresponds to Example 5.

FIG. 6 is a cross-sectional view of an imaging lens according to one embodiment of the present disclosure, illustrating a sixth configuration example, which corresponds to Example 6.

FIG. 7 is a cross-sectional view of an imaging lens according to one embodiment of the present disclosure, illustrating a seventh configuration example, which corresponds to Example 7.

FIG. 8 is a cross-sectional view of an imaging lens according to one embodiment of the present disclosure, illustrating an eighth configuration example, which corresponds to Example 8.

FIG. 9 is a cross-sectional view of an imaging lens according to one embodiment of the present disclosure, illustrating a ninth configuration example, which corresponds to Example 9.

FIG. 10 is a cross-sectional view of an imaging lens according to one embodiment of the present disclosure, illustrating a tenth configuration example, which corresponds to Example 10.

FIG. 11 is a cross-sectional view of an imaging lens according to one embodiment of the present disclosure, illustrating an eleventh configuration example, which corresponds to Example 11.

FIG. 12 is a cross-sectional view of an imaging lens according to one embodiment of the present disclosure, illustrating a twelfth configuration example, which corresponds to Example 12.

FIG. 13 is a ray diagram of the imaging lens illustrated in FIG. 1.

FIG. 14 shows aberration diagrams of the imaging lens according to Example 1 of the present disclosure, in which spherical aberration, astigmatism, distortion, and lateral chromatic aberration are illustrated in order from the left.

FIG. 15 shows aberration diagrams of the imaging lens according to Example 2 of the present disclosure, in which spherical aberration, astigmatism, distortion, and lateral chromatic aberration are illustrated in order from the left.

FIG. 16 shows aberration diagrams of the imaging lens according to Example 3 of the present disclosure, in which spherical aberration, astigmatism, distortion, and lateral chromatic aberration are illustrated in order from the left.

FIG. 17 shows aberration diagrams of the imaging lens according to Example 4 of the present disclosure, in which spherical aberration, astigmatism, distortion, and lateral chromatic aberration are illustrated in order from the left.

FIG. 18 shows aberration diagrams of the imaging lens according to Example 5 of the present disclosure, in which spherical aberration, astigmatism, distortion, and lateral chromatic aberration are illustrated in order from the left.

FIG. 19 shows aberration diagrams of the imaging lens according to Example 6 of the present disclosure, in which spherical aberration, astigmatism, distortion, and lateral chromatic aberration are illustrated in order from the left.

FIG. 20 shows aberration diagrams of the imaging lens according to Example 7 of the present disclosure, in which spherical aberration, astigmatism, distortion, and lateral chromatic aberration are illustrated in order from the left.

FIG. 21 shows aberration diagrams of the imaging lens according to Example 8 of the present disclosure, in which spherical aberration, astigmatism, distortion, and lateral chromatic aberration are illustrated in order from the left.

FIG. 22 shows aberration diagrams of the imaging lens according to Example 9 of the present disclosure, in which spherical aberration, astigmatism, distortion, and lateral chromatic aberration are illustrated in order from the left.

FIG. 23 shows aberration diagrams of the imaging lens according to Example 10 of the present disclosure, in which spherical aberration, astigmatism, distortion, and lateral chromatic aberration are illustrated in order from the left.

FIG. 24 shows aberration diagrams of the imaging lens according to Example 11 of the present disclosure, in which spherical aberration, astigmatism, distortion, and lateral chromatic aberration are illustrated in order from the left.

FIG. 25 shows aberration diagrams of the imaging lens according to Example 12 of the present disclosure, in which spherical aberration, astigmatism, distortion, and lateral chromatic aberration are illustrated in order from the left.

FIG. 26 illustrates an imaging apparatus, which is a cell phone terminal, equipped with the imaging lens according to the present disclosure.

FIG. 27 illustrates an imaging apparatus, which is a smartphone, equipped with the imaging lens according to the present disclosure.

### DETAILED DESCRIPTION OF THE PREFERRED EMBODIMENTS

Hereinafter, embodiments of the present disclosure will be described in detail with reference to the accompanying drawings.

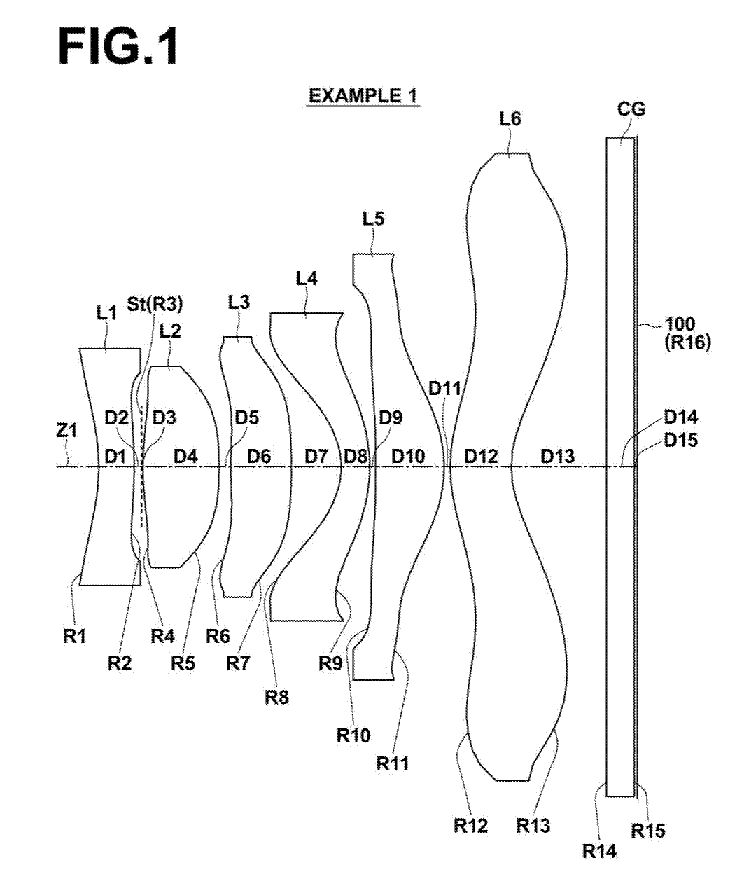

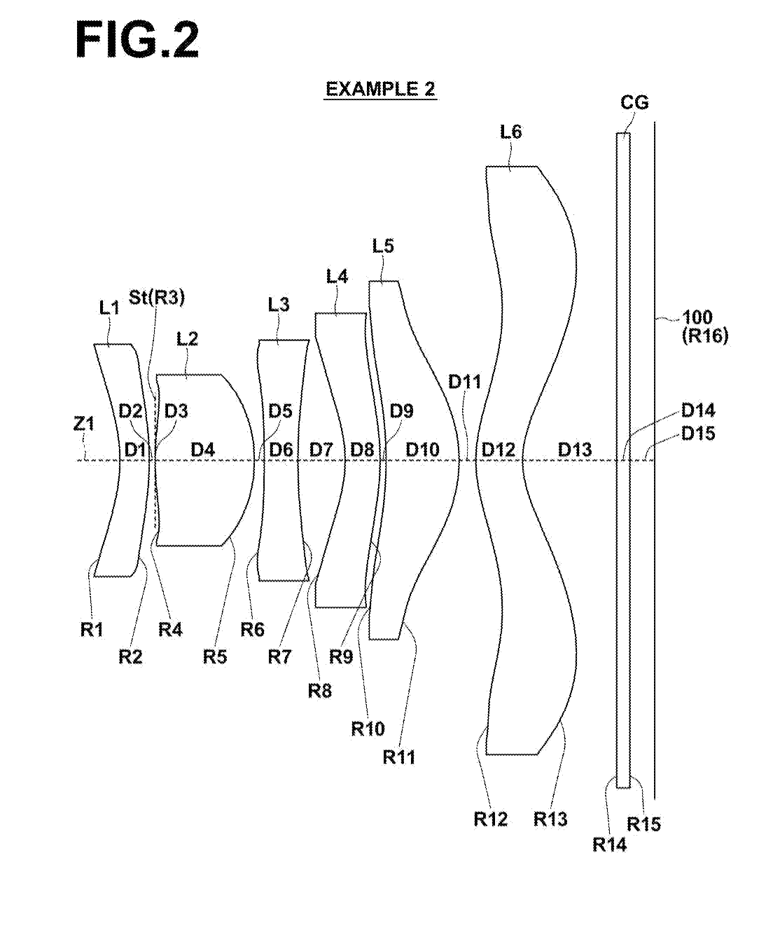

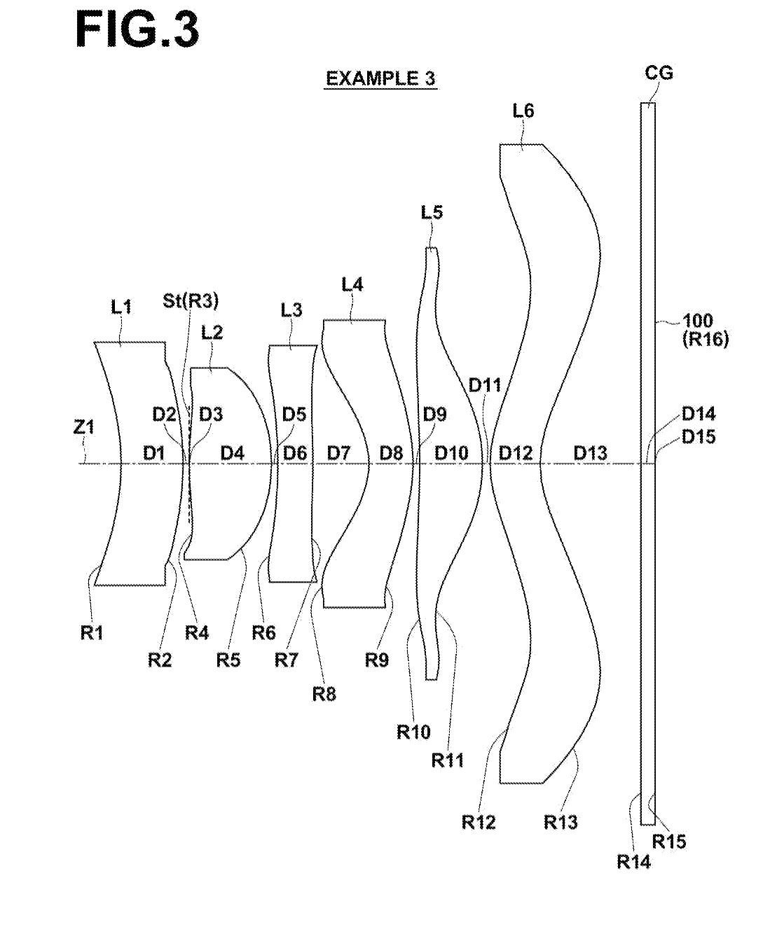

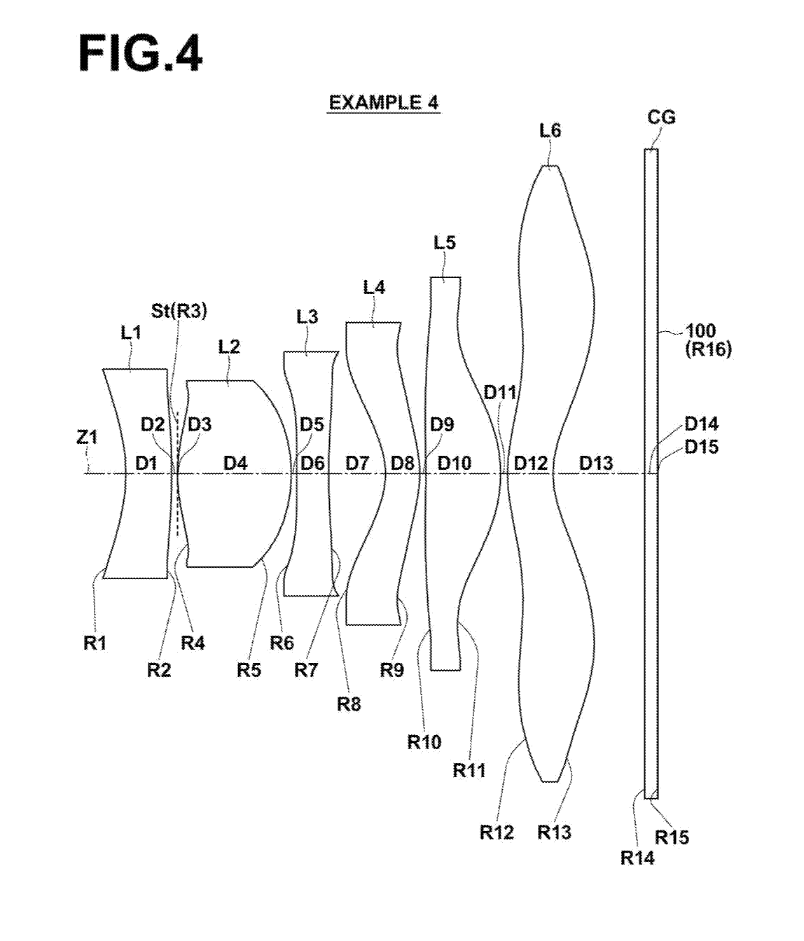

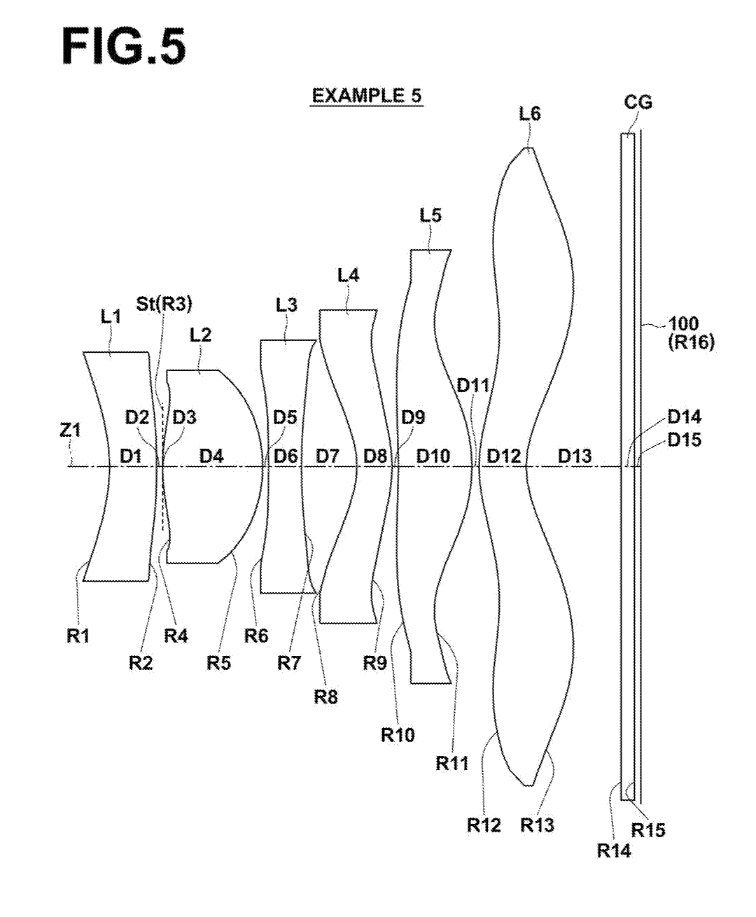

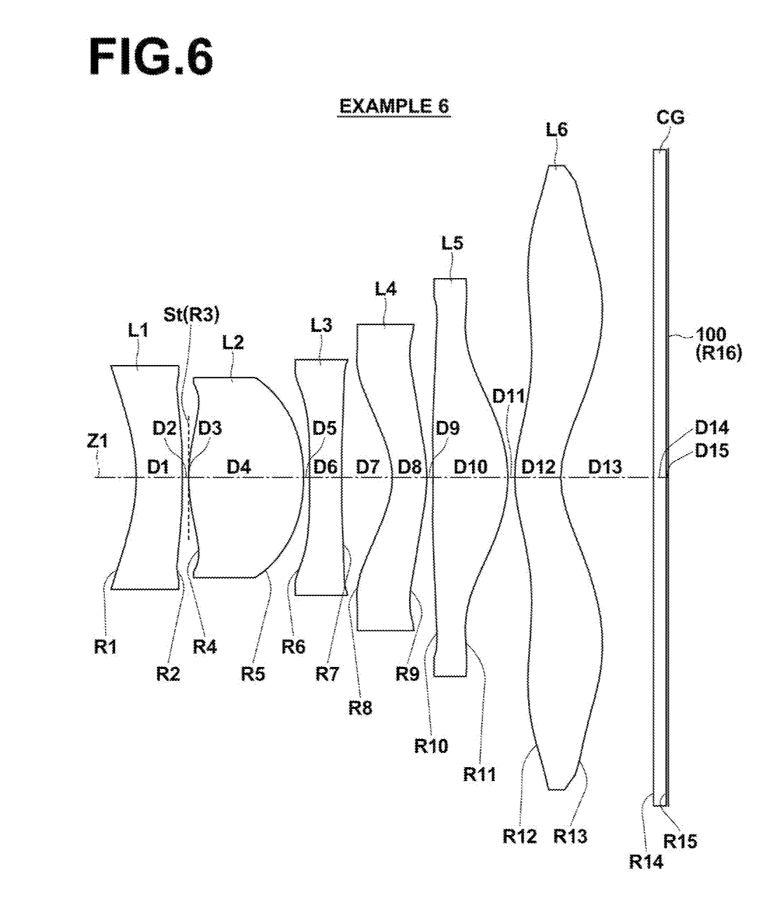

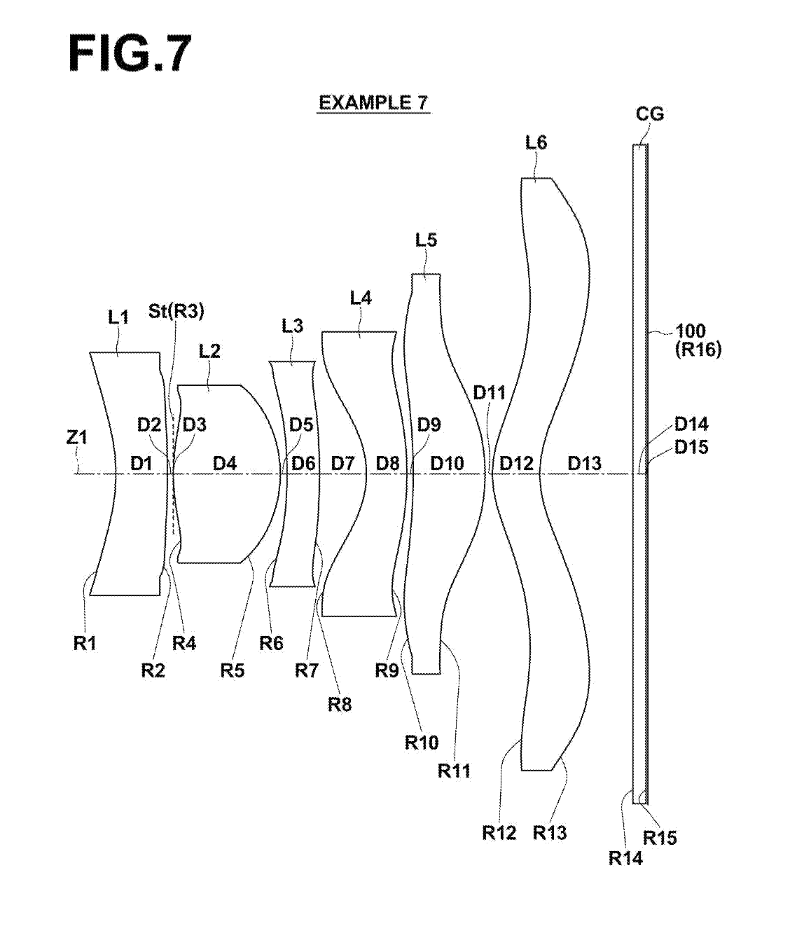

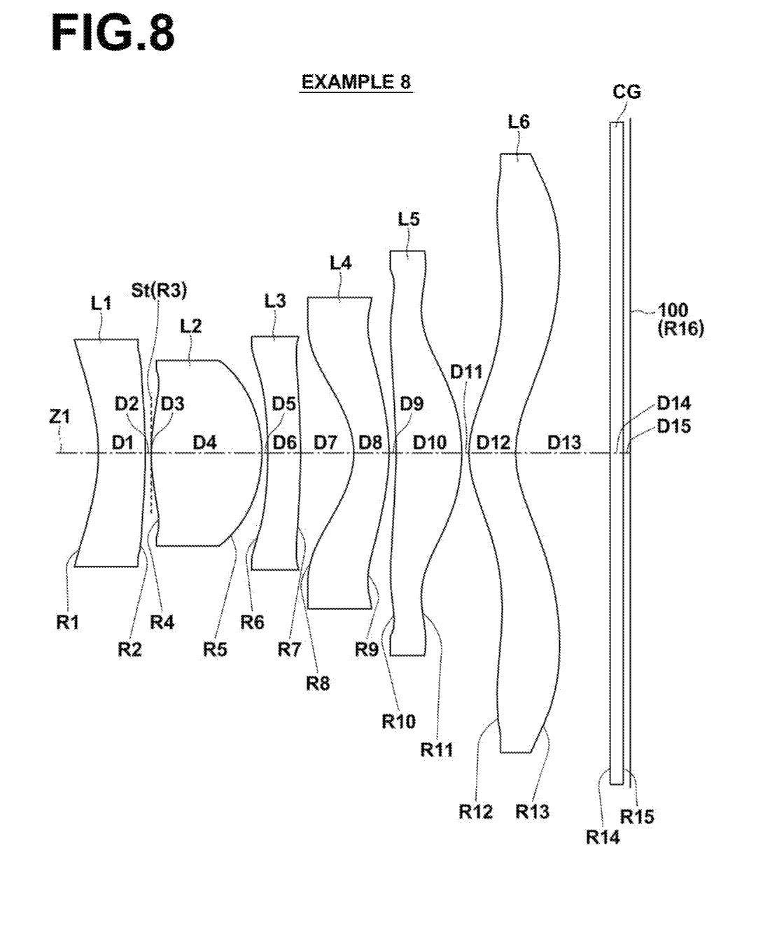

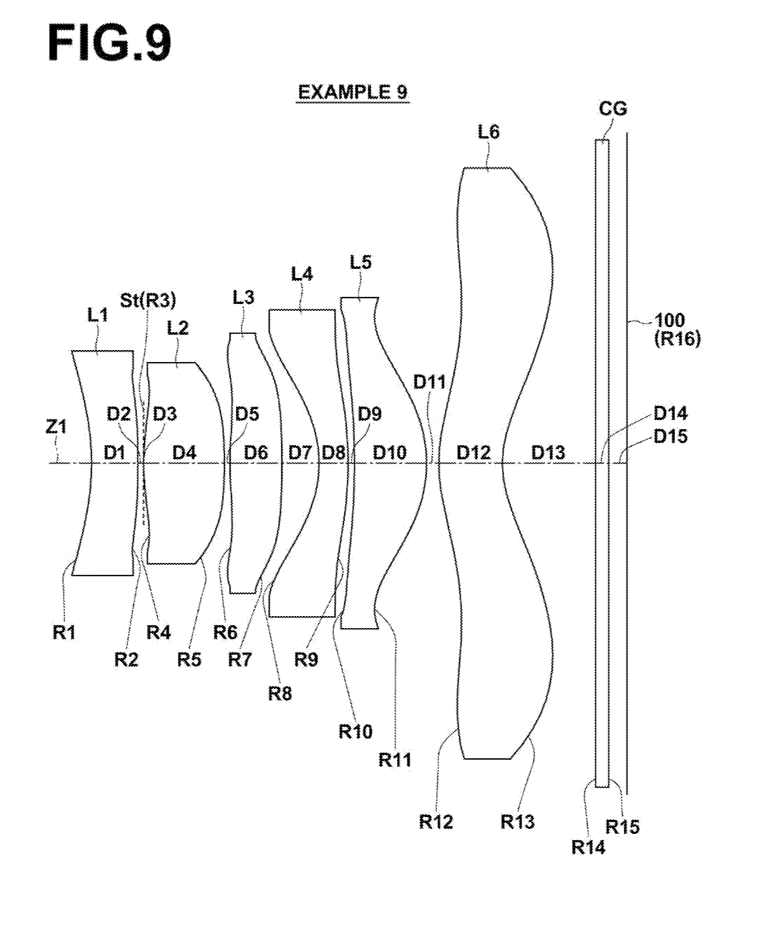

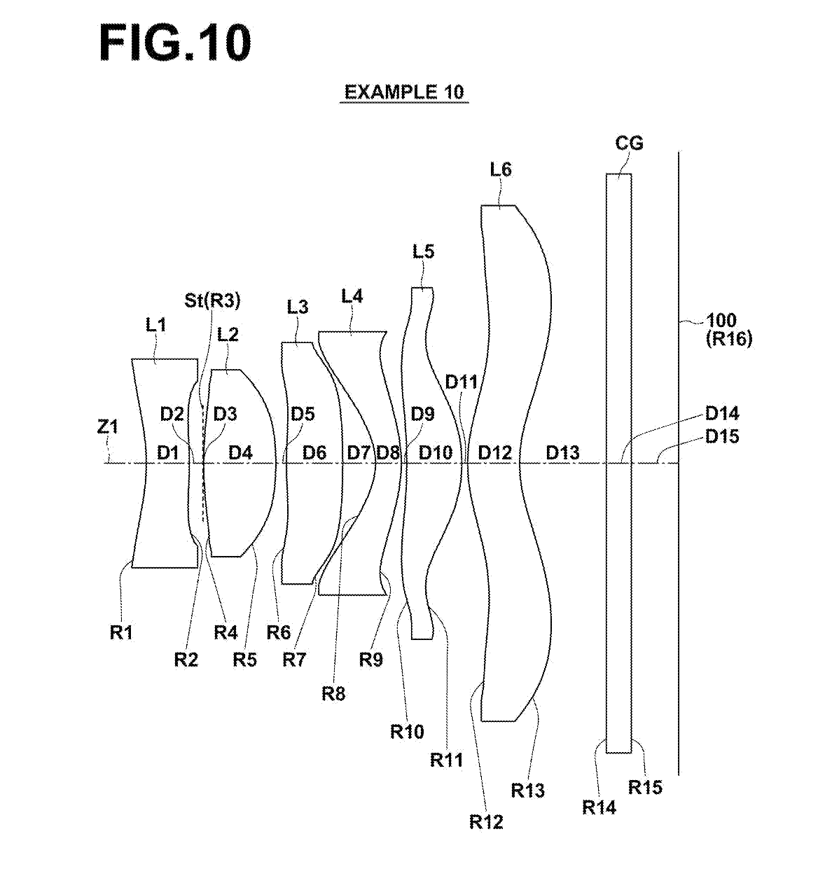

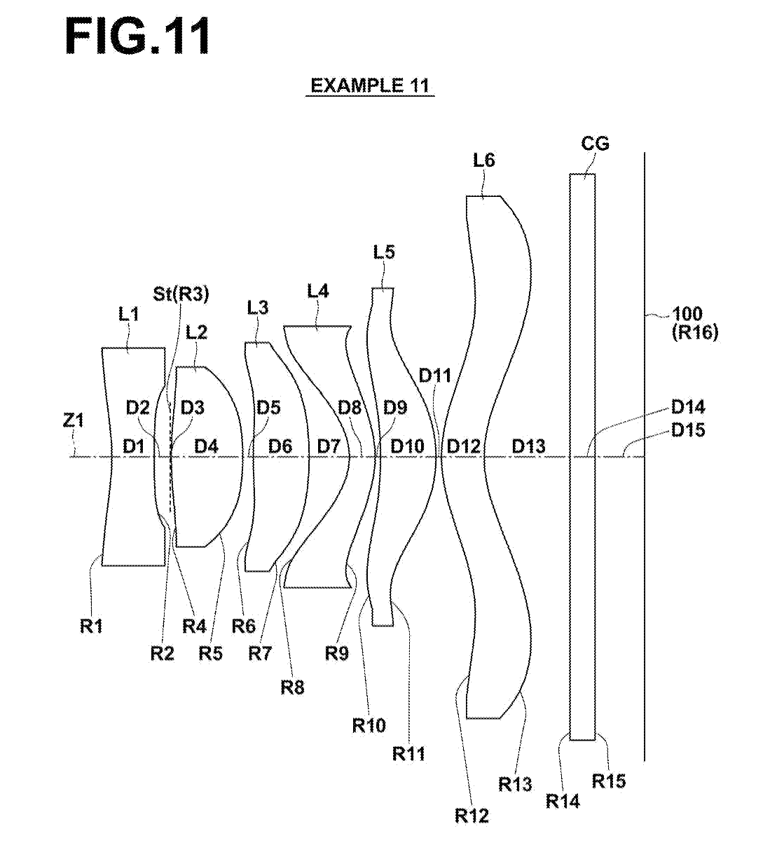

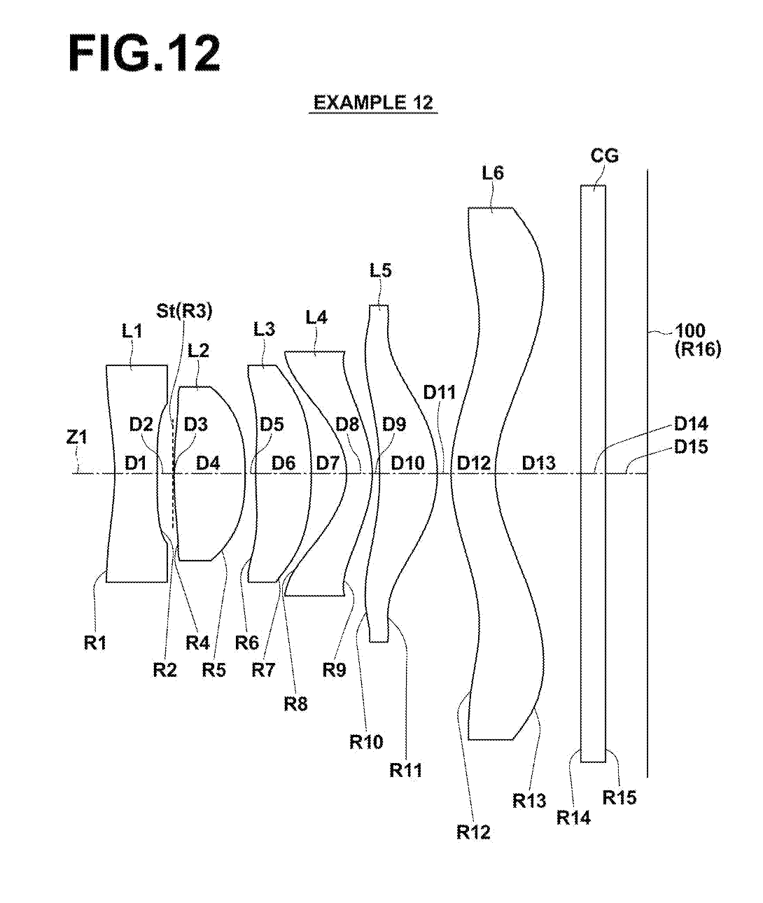

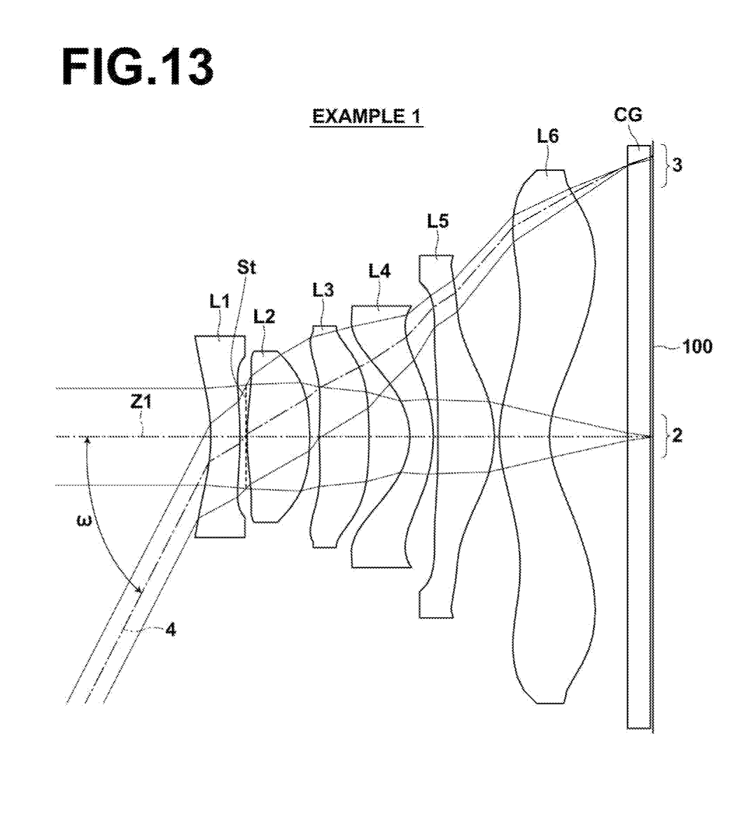

FIG. 1 illustrates a first configuration example of an imaging lens according to a first embodiment of the present disclosure. This configuration example corresponds to the lens configuration of a first numerical example (Tables 1 and 2) to be described later. Likewise, second to twelfth configuration examples in cross-section corresponding to numerical examples (Tables 3 to 24) according to the second to twelfth embodiments, to be described later, are shown in FIG. 2 to FIG. 12 respectively. In FIG. 1 to FIG. 12, the symbol Ri indicates a radius of curvature of i^{th} surface in which a number i is given to each surface in a serially increasing manner toward the image side (imaging side) with the most object side lens element surface being taken as the first surface. The symbol Di indicates a surface distance between i^{th} surface and (i+1)^{th} surface on the optical axis Z1. As the basic configuration of each configuration example is identical, a description will be made, hereinafter, based on the configuration example of imaging lens shown in FIG. 1, and the configuration examples shown in FIG. 2 to FIG. 12 will be described, as required. FIG. 13 is a ray diagram of the imaging lens shown in FIG. 1, illustrating each optical path of an axial light beam 2 and a maximum angle of view light beam 3, and a maximum half angle of view co when an object at infinity is in focus. Note that the principal ray 4 of the maximum angle of view light beam 3 is illustrated by a dot-and-dash line.

An imaging lens L according to an embodiment of the present disclosure is suitable for use in various types of imaging devices and systems that use image sensors such as, for example, a CCD and a CMOS, in particular, relatively small portable terminal devices and systems, including digital still cameras, camera-equipped cell phones, smartphones, tablet terminals, and PDAs. The imaging lens L includes a first lens L1, a second lens L2, a third lens L3, a fourth lens L4, a fifth lens L5, and a sixth lens L6 in order from the object side along the optical axis Z1.

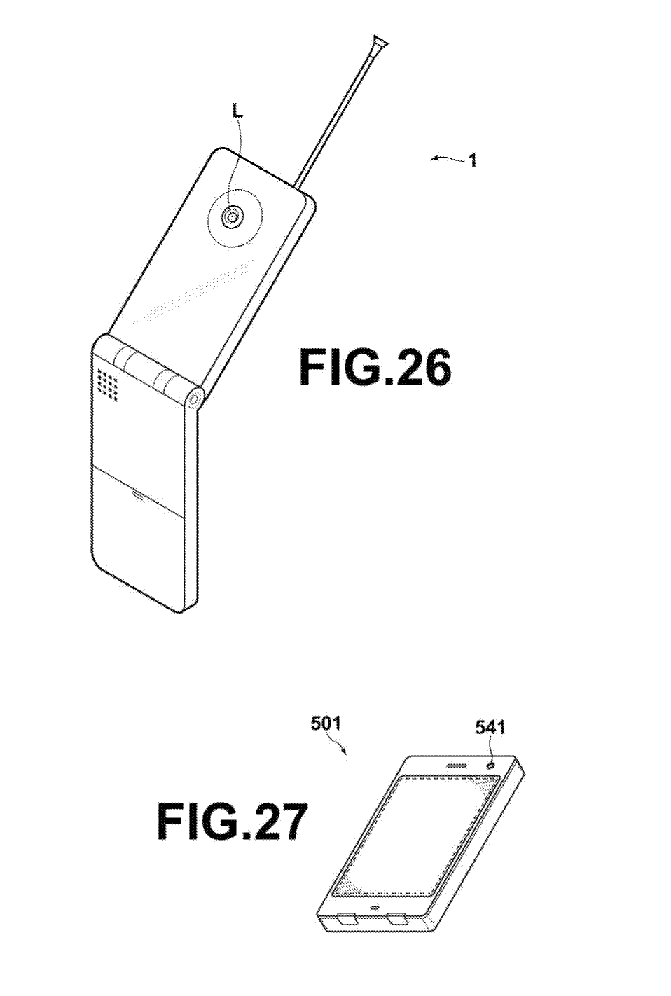

FIG. 26 is a schematic view of a cell phone terminal which is an imaging apparatus 1 according to an embodiment of the present disclosure. The imaging apparatus 1 according to an embodiment of the present disclosure includes the imaging lens L according to the present embodiment and an image sensor 100 (refer to FIG. 1 to FIG. 12), such as a CCD, that outputs an imaging signal according to an optical image formed by the imaging lens L. The image sensor 100 is disposed on the imaging surface (image plane R16 in FIG. 1 to FIG. 12) of the imaging lens L.

FIG. 27 is a schematic view of a smartphone which is an imaging apparatus 501 according to an embodiment of the present disclosure. The imaging apparatus 501 according to an embodiment of the present disclosure includes a camera section 541 which includes the imaging lens L according to the present embodiment and an image sensor 100 (refer to FIG. 1 to FIG. 12), such as a CCD, that outputs an imaging signal according to an optical image formed by the imaging lens L. The image sensor 100 is disposed on the imaging surface (image plane) of the imaging lens L.

Various types of optical members CG may be disposed between the sixth lens L6 and the image sensor 100 according to the camera side structure to which the lens is mounted. For example, a plate-like optical member, for example, a cover glass for protecting the image plane or an infrared cut filter may be disposed. In this case, for example, a plate-like cover glass with a coating having a filtering effect, such as an infrared cut filter or an ND filter, or with a material having an identical effect may be used as the optical member CG

Further, an effect comparable to that of the optical member CG may be given by applying a coating on the sixth lens L6, without using the optical member CG This allows a reduction in the number of parts and the overall length.

Preferably, the imaging lens L includes an aperture stop St disposed on the object side of the object side surface of the second lens L2. Disposing the aperture stop St in such a manner may prevent the incident angles of light rays passing through the optical system with respect to the imaging surface (image sensor) from increasing, in particular, in a peripheral portion of the imaging area. The term “disposed on the object side of the object side surface of the second lens L2” as used herein refers to that the position of the aperture stop St in an optical axis direction is located at the same position as the intersection between the axial marginal ray and the object side surface of the second lens L2 or on the object side of the intersection. Further, the aperture stop St may be disposed between the first lens L1 and the second lens L2. In this case, aberrations may be corrected by the lens disposed on the object side of the aperture stop St and the lenses disposed on the image side of the aperture stop St in a well-balanced manner, while reducing the overall length. In the present embodiment, the lenses of the first to twelfth configuration examples (FIG. 1 to FIG. 12) are those, each having an aperture stop St disposed between the first lens L1 and the second lens L2. The aperture stop St shown here does not necessarily represent the size or the shape but indicates the position on the optical axis Z1.

The first lens L1 has a negative refractive power near the optical axis. This allows, when a light ray that has passed through a peripheral portion of the first lens L1 (light ray in the peripheral angle of view) is incident on the second lens L2, the angle with respect to the optical axis (incident angle with respect to the plane with the optical axis as a normal line) to be reduced, whereby a satisfactory increase in the angle of view may be realized. The first lens L1 has a concave surface on the object side near the optical axis. This makes it easy to increase the angle of view to the extent in which the negative refractive power of the first lens L1 is not increased too strong, which is advantageous for reducing the overall lens length. Further, the first lens L1 may have a biconcave shape. In this case, the negative refractive power may be shared by the object side surface and the image side of the first lens L1 to prevent the absolute values of the paraxial radii of curvature of the object side surface and the image side surface from being too small, whereby generation of spherical aberration may be suppressed. Still further, the first lens L1 may have a meniscus shape with a concave surface on the object side. In this case, the rear principal point of the first lens L1 may be shifted easily to the image side, which makes it easy to secure a required back focus.

The second lens L2 has a positive refractive power near the optical axis. This allows a satisfactory reduction in the overall lens length. Preferably, the second lens L2 has a biconvex shape near the optical axis. In this case, the positive refractive power may be shared by the object side surface and the image side surface of the second lens L2 to secure a sufficient positive refractive power, whereby generation of spherical aberration may be suppressed while realizing a satisfactory reduction in the overall lens length.

The third lens L3 may have a negative or positive refractive power near the optical axis if it is capable of correcting various aberration generated while light rays pass through the imaging lens L in a well-balanced manner. In a case where the third lens L3 has a positive refractive power near the optical axis, it is easy to secure the positive refractive power of the imaging lens L, which is advantageous for reducing the overall lens length. For example, the third lens L3 may have a biconvex shape near the optical axis. In this case, generation of spherical aberration may be suppressed satisfactorily. In a case where the third lens L3 has a negative refractive power near the optical axis, chromatic aberration and spherical aberration may be corrected satisfactorily. For example, the third lens L3 may have a biconcave shape near the optical axis. In this case, generation of spherical aberration may be corrected more satisfactorily. Still further, the third lens L3 may have a negative refractive power near the optical axis and a meniscus shape with a concave surface on the object side near the optical axis. In this case, astigmatism may be corrected more satisfactorily.

Preferably, the fourth lens L4 has a negative refractive power near the optical axis. In this case, astigmatism and longitudinal chromatic aberration may be corrected satisfactorily, which is advantageous for realizing an increase in the angle of view. Further, the fourth lens L4 has a meniscus shape with a concave surface on the object side near the optical axis. This allows astigmatism to be corrected satisfactorily.

Preferably, the fifth lens L5 has a positive refractive power near the optical axis. In this case, the overall lens length may be reduced satisfactorily. Further, the fifth lens L5 has a meniscus shape with a concave surface on the object side near the optical axis. This allow astigmatism to be corrected satisfactorily, which is advantageous for realizing an increase in the angle of view and a small F-number.

Preferably, the sixth lens L6 has a negative refractive power near the optical axis. Giving a negative refractive power to the sixth lens L6, which is the lens disposed on the most image side of the imaging lens L, near the optical axis allows the rear principal point of the imaging lens L to be shifted to the object side, whereby the overall lens length may be reduced satisfactorily. Further, the sixth lens L6 has a meniscus shape with a convex surface on the object side near the optical axis. This makes it easy to shift the rear principal point of the imaging lens L to the object side, whereby a satisfactory reduction in the overall lens length may be achieved and field curvature may be corrected satisfactorily.

Preferably, the image side surface of the sixth lens L6 has an aspherical surface with at least one inflection point located radially inward from the intersection between the image side surface and the principal ray of the maximum angle of view toward the optical axis. In this case, incident angles of light rays passing through the optical system with respect to the imaging surface (image sensor) may be prevented from increasing, in particular, in a peripheral portion of the imaging area. Forming the image side surface of the sixth lens L6 in an aspherical shape with at least one inflection point located radially inward from the intersection between the image side surface and the principal ray of the maximum angle of view toward the optical axis allows distortion to be corrected satisfactorily. The term “inflection point” on the image side surface of the sixth lens L6 refers to a point where the surface shape of the image side surface changes from a convex shape to a concave shape (or from a concave shape to a convex shape) toward the image side. The term “radially inward from the intersection between the image side surface and the principal ray of the maximum angle of view toward the optical axis” as used herein refers to the same position as the intersection between the image side surface and the principal ray of the maximum angle of view or a position located further radially inward from the intersection toward the optical axis. The inflection point on the image side surface of the sixth lens L6 may be disposed at the same position as the intersection between the image side surface of the sixth lens L6 and the principal ray of the maximum angle of view or at any position further radially inward from the intersection toward the optical axis.

The use of single lenses for the first lens L1 to the sixth lens L6 constituting the imaging lens L described above may increase the number of lens surfaces in comparison with the case where a cemented lens is used for any of the first lens L1 to the sixth lens L6, whereby design flexibility may be increased and the overall lens length may be reduced satisfactorily.

According to the imaging lens L described above, the configuration of each lens element is optimized in a lens configuration of six elements in total. This allows realization of a lens system having high imaging performance from the central angle of view to the peripheral angle of view that satisfies the demand for a higher pixelation in which an increase in the angle of view and a small F-number are achieved.

Preferably, each of the first lens L1 to the sixth lens L6 of the imaging lens L has an aspherical shape on at least one surface for higher performance of the imaging lens L.

Next, operations and effects of the imaging lens L configured in the manner described above will be described in further detail with respect to conditional expressions. Preferably, the imaging lens L satisfies any one or any combination of the following conditional expressions. Preferably, a conditional expression to be satisfied by the imaging lens L is selected, as appropriate, according to the requirements of the imaging lens L.

Preferably, the distance TTL from the object side surface of the first lens L1 to the image plane on the optical axis when an air equivalent length is used for the back focus (distance from the image side surface of the sixth lens L6 to the image plane on the optical axis) and the focal length f of the entire system satisfy the following conditional expression (1):

TTL/f<3 (1).

The conditional expression (1) defines a preferable numerical range of the ratio of the distance TTL from the object side surface of the first lens L1 to the image plane (overall lens length) with respect to the focal length f of the entire system. Maintaining the distance TTL from the object side surface of the first lens L1 to the image plane with respect to the focal length f of the entire system such that the value of the conditional expression (1) remains below the upper limit allow the entire lens length to be reduced satisfactorily. In order to further enhance the foregoing effects, it is more preferable that the following conditional expression (1-1) (or conditional expression (1-3)) is satisfied. Further, the distance TTL from the object side surface of the first lens L1 to the image plane with respect to the focal length f of the entire system is preferably secured such that the value of the conditional expression (1-2) (or conditional expression (1-3)) remains above the lower limit. In this case, aberrations, in particular, field curvature and distortion may be corrected satisfactorily.

TTL/f<2.5 (1-1)

1<TTL/f<3 (1-2)

1<TTL/f<2.5 (1-3)

Preferably, the focal length f1 of the first lens L1 and the focal length f of the entire system satisfy the following conditional expression (2):

−2<f/f1<0 (2).

The conditional expression (2) defines a preferable numerical range of the ratio of the focal length f of the entire system with respect to the focal length f1 of the first lens L1. Suppressing the refractive power of the first lens L1 such that the value of the conditional expression (2) remains above the lower limit may prevent the refractive power of the first lens L1 from being too strong relative to the refractive power of the entire system, whereby the overall length may be reduced satisfactorily. Securing the focal length f1 of the first lens L1 such that the value of the conditional expression (2) remains below the upper limit may prevent the negative refractive power of the first lens L1 from being too weak relative to the refractive power of the entire system, whereby a satisfactory increase in the angle of view may be achieved. In order to further enhance the foregoing effects, it is more preferable that the following conditional expression (2-1) is satisfied:

1.5<f/f1<−0.05 (2-1).

Preferably, the focal length f2 of the second lens L2 and the focal length f of the entire system satisfy the following conditional expression (3):

0<f/f2<3 (3).

The conditional expression (3) defines a preferable numerical range of the ratio of the focal length f of the entire system with respect to the focal length f2 of the second lens L2. Securing the refractive power of the second lens L2 such that the value of the conditional expression (3) remain above the lower limit may prevent the refractive power of the second lens L2 from being too weak relative to the refractive power of the entire system, whereby a satisfactory reduction in the overall lens length may be realized. Suppressing the refractive power of the second lens L2 such that the value of the conditional expression (3) remains below the upper limit may prevent the positive refractive power of the second lens L2 from being too strong, whereby spherical aberration and astigmatism at a low angle of view may be corrected satisfactorily. In order to further enhance the foregoing effects, it is more preferable that the following conditional expression (3-1) is satisfied:

0.5<f/f2<2.5 (3-1).

Preferably, the focal length f3 of the third lens L3 and the focal length f of the entire system satisfy the following conditional expression (4):

0.95<f/f3<0.95 (4).

The conditional expression (4) defines a preferable numerical range of the ratio of the focal length f of the entire system with respect to the focal length f3 of the third lens L3. Suppressing the refractive power of the third lens L3 such that the value of the conditional expression (4) remains above the lower limit may prevent the refractive power of the third lens L3 from being too strong relative to the refractive power of the entire system, which is advantageous for reducing the overall lens length. Keeping the value of the conditional expression (4) above the lower limit may prevent spherical aberration from being under-corrected, which is advantageous for realizing a small F-number. Suppressing the refractive power of the third lens L3 such that the value of the conditional expression (4) remains below the upper limit may prevent the refractive power of the third lens L3 from being too strong relative to the refractive power of the entire system, whereby spherical aberration is prevented from being under-corrected, which is advantageous for realizing a small F-number. In order to further enhance the foregoing effects, it is more preferable that the following conditional expression (4-1) is satisfied:

0.85<f/f3<0.85 (4-1).

Preferably, the focal length f4 of the fourth lens L4 and the focal length f of the entire system satisfy the following conditional expression (5):

−2<f/f4<0 (5).

The conditional expression (5) defines a preferable numerical range of the ratio of the focal length f of the entire system with respect to the focal length f4 of the fourth lens L4. Suppressing the refractive power of the fourth lens L4 such that the value of the conditional expression (5) remains above the lower limit may prevent the negative refractive power of the fourth lens L4 from being too strong relative to the refractive power of the entire system, whereby spherical aberration is prevented from being over-corrected. Suppressing the refractive power of the fourth lens L4 such that the value of the conditional expression (5) remains below the upper limit may prevent the negative refractive power of the fourth lens L4 from being too weak relative to the refractive power of the entire system, whereby astigmatism and longitudinal chromatic aberration may be corrected satisfactorily, which is advantageous for realizing an increase in the angle of view. In order to further enhance the foregoing effects, it is more preferable that the following conditional expression (5-1) is satisfied:

1.5<f/f4<0 (5-1).

Preferably, the focal length f5 of the fifth lens L5 and the focal length f of the entire system satisfy the following conditional expression (6):

0<f/f5<2 (6).

The conditional expression (6) defines a preferable numerical range of the ratio of the focal length f of the entire system with respect to the focal length f5 of the fifth lens L5. Securing the refractive power of the fifth lens L5 such that the value of the conditional expression (6) remains above the lower limit may prevent the positive refractive power of the fifth lens L5 from being too weak relative to the refractive power of the entire system, whereby the overall lens length may be reduced satisfactorily. Suppressing the refractive power of the fifth lens L5 such that the value of the conditional expression (6) remains below the upper limit may prevent the positive refractive power of the fifth lens L5 from being too strong relative to the refractive power of the entire system, whereby lateral chromatic aberration may be corrected satisfactorily. In order to further enhance the foregoing effects, it is more preferable that the following conditional expression (6-1) is satisfied:

0<f/f5<1.5 (6-1).

Preferably, the focal length f of the entire system and the paraxial radius of curvature L6r of the image side surface of the sixth lens L6 satisfy the following conditional expression (7):

1<f/L6r<4 (7).

The conditional expression (7) defines a preferable numerical range of the ratio of the focal length f of the entire system with respect to the paraxial radius of curvature of the image side surface of the sixth lens L6. Setting the paraxial radius of curvature L6r of the image side surface of the sixth lens L6 such that the value of the conditional expression (7) remains above the lower limit may prevent the absolute value of the paraxial radius of curvature of the image side surface of the sixth lens L6 from being too large relative to the focal length f of the entire system, which is advantageous for reducing the overall lens length. Setting the paraxial radius of curvature L6r of the image side surface of the sixth lens L6 such that the value of the conditional expression (7) remains below the upper limit may prevent may prevent the absolute value of the paraxial radius of curvature of the image side surface of the sixth lens L6 from being too small relative to the focal length f of the entire system, whereby field curvature and distortion may be corrected satisfactorily, in particular, at an intermediate angle of view. In order to further enhance the foregoing effects, it is more preferable that the following conditional expression (7-1) is satisfied:

1<f/L6r<3.5 (7-1).

Preferably, the paraxial radius of curvature L4f of the object side surface of the fourth lens L4 and the paraxial radius of curvature L4r of the image side surface of the fourth lens L4 satisfy the following conditional expression (8):

1<(L4r+L40/(L4r−L4f)<10 (8).

The conditional expression (8) defines a preferable numerical range for the paraxial radius of curvature L4f of the object side surface of the fourth lens L4 and the paraxial radius of curvature L4r of the image side surface of the fourth lens L4. Forming the fourth lens L4 such that the value of the conditional expression (8) remains above the lower limit allows astigmatism to be corrected satisfactorily. Forming the fourth lens L4 such that the value of the conditional expression (8) remains below the upper limit is advantageous for reducing the overall lens length. In order to further enhance the foregoing effects, it is more preferable that the following conditional expression (8-1) is satisfied:

1<(L4r+L4f)/(L4r−L4f)<7.5 (8-1).

As described above, according to the imaging lens L of an embodiment of the present disclosure, the configuration of each lens element is optimized in a lens configuration of six elements in total. This allows realization of a lens system having high imaging performance from the central angle of view to the peripheral angle of view that satisfies the demand for a higher pixelation in which an increase in the angle of view and a smaller F-number are achieved.

Satisfying a preferable condition, as appropriate, allows a higher imaging performance to be realized. According to the imaging apparatus of the present embodiment, a high resolution captured image may be obtained from the central angle of view to the peripheral angle of view, since the apparatus is configured to output an imaging signal according to an optical image formed by the imaging lens having high performance of the present embodiment.

For example, in the imaging lenses according to the first to the twelfth embodiments, the first lens L1 to the sixth lens L6 of the imaging lens L are configured so as to have a maximum angle of view of 110 degrees or more when an object at infinity is in focus with a small F-number of 2.5 or less. Therefore, the imaging lens L may be preferably employed as an imaging lens required of a wide angle of view and a small F-number, such as those used in portable terminals and the like. Further, according to the first to the twelfth embodiments, the first lens L1 to the sixth lens L6 of the imaging lens L are configured so as to have an F-number of 2.4 or less. This may respond to the demand for realizing a small F-number more favorably. Still further, configuring the first lens L1 to the sixth lens L6 such that the ratio of the overall lens length with respect to the focal length of the entire system (TTL/f) is 2.3 or less, as in, for example, the imaging lenses according to the first to the twelfth embodiments, may also respond favorably to the demand for reducing the overall length of a lens used in a portable terminal and the like.

Next, specific numerical examples of imaging lenses according to the embodiments of the present disclosure will be described. Hereinafter, a plurality of numerical examples is described collectively.

Tables 1 and 2, to be described later, show specific lens data corresponding to the configuration of the imaging lens illustrated in FIG. 1. More specifically, Table 1 shows basic lens data, while Table 2 shows aspherical surface data. The surface number Si column in the lens data shown in Table 1 indicates i^{th} surface number of the imaging lens according to Example 1 in which a number i is given to each surface in a serially increasing manner toward the image side with the object side surface of the most object side optical element being taken as the first surface. The radius of curvature Ri column indicates the value (mm) of radius of curvature of i^{th} surface from the object side in relation to the symbol Ri given in FIG. 1. Likewise, the surface distance Di column indicates the surface distance (mm) on the optical axis between i^{th} surface Si and (i+1)^{th} surface Si+1. The Ndj column indicates the value of the refractive index of j^{th} optical element from the object side with respect to the d-line (wavelength 587.6 nm) and the vdj column indicates the value of the Abbe number of j^{th} optical element from the object side with respect to the d-line.

Table 1 also includes the aperture stop St and the optical member CG In Table 1, the term (St) is indicated in the surface number column of the surface corresponding to the aperture stop St in addition to the surface number, and the term (IMG) is indicated in the surface number column of the surface corresponding to the image plane in addition to the surface number. The sign of the radius of curvature is positive if the surface shape is convex on the object side and negative if it is convex on the image side. As various types of data, values of focal length f (mm) of the entire system, back focus Bf (mm), F-number Fno., and maximum angle of view 2ω(°) when an object at infinity is in focus are given in the upper margin of each lens data. Note that the back focus Bf indicates an air equivalent value.

In the imaging lens according to Example 1, both surfaces of the first lens L1 to the sixth lens L6 have aspherical surface shapes. As the radii of curvature of these aspherical surfaces, the basic lens data of Table 1 show numerical values of radii of curvature near the optical axis (paraxial radii of curvature).

Table 2 shows aspherical surface data of the imaging lens of Example 1. In a numerical value shown as aspherical surface data, the symbol “E” indicates that the subsequent numerical value is an “exponent” to base 10 and the numerical value preceding “E” is multiplied by the numerical value represented by the exponent to base 10. For example, “1.0E-02” represents “1.0×10⁻²”.

As for the aspherical surface data, values of each coefficient An and KA in an aspherical surface shape formula represented by the following formula (A) are indicated. More specifically, Z indicates the length (mm) of a vertical line from a point on the aspheric surface at a height h to a tangential plane of the vertex of the aspherical surface (plane orthogonal to the optical axis).

$$Z = \frac{C \times {h}^{2}}{1 + \sqrt{1 - KA \times {C}^{2} \times {h}^{2}}} + {\sum }_{n} An \times {h}^{n} \qquad ( A )$$

where:

Z: depth of the aspherical surface (mm)

h: distance from the optical axis to the lens surface (height) (mm)

C: paraxial curvature=1/R (R: paraxial radius of curvature)

An: n^{th} order aspherical surface coefficient (n is an integer not less than 3)

KA: aspherical surface coefficient

As in the foregoing imaging lens of Example 1, specific lens data corresponding to the imaging lens configurations illustrated in FIG. 2 to FIG. 12 are given in Tables 3 to 24, as Examples 2 to 12. In the imaging lenses according to Example 1 to 12, both surfaces of the first lens L1 to the sixth lens L6 have aspherical shapes.

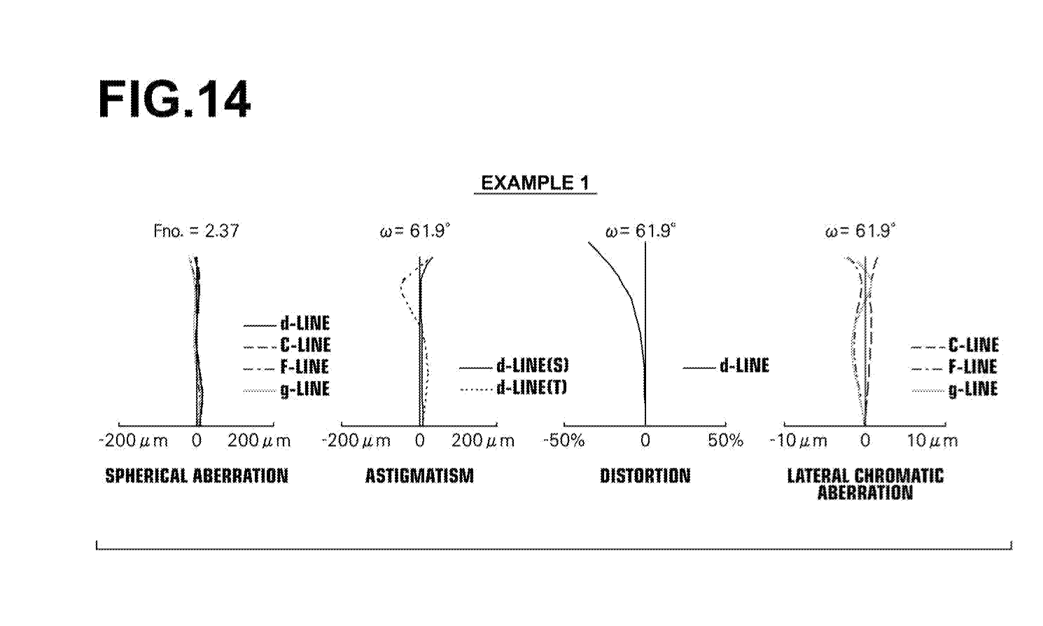

FIG. 14 shows aberration diagrams representing spherical aberration, astigmatism, distortion, and lateral chromatic aberration of Example 1 in order from the left. Each aberration diagram of spherical aberration, astigmatism (field curvature), and distortion illustrates aberration with the d-line (wavelength 587.6 nm) as the reference wavelength, but the spherical aberration diagram also illustrates aberrations with respect to the F-line (wavelength 486.1 nm), the C-line (wavelength 656.3 nm), and the g-line (435.8 nm), while the lateral chromatic aberration diagram illustrates aberrations with respect to the F-line, the C-line, and the g-line. In the astigmatism diagram, the solid line illustrates aberration in the sagittal direction (S) and the broken line illustrates aberration in the tangential direction (T). The Fno. and o represent the F-number and the maximum half angle of view when an object at infinity is in focus respectively.

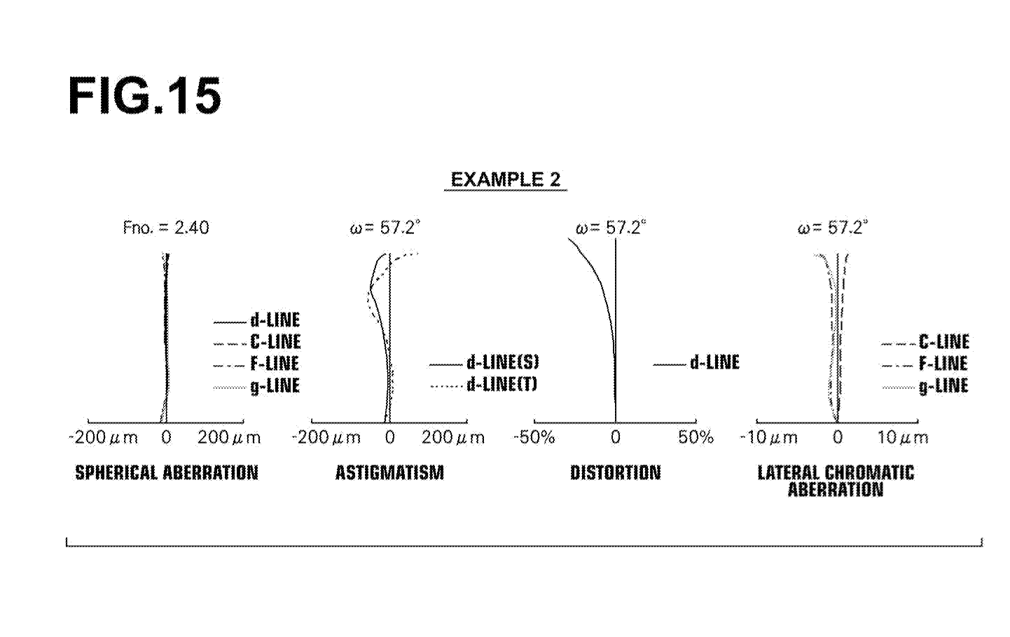

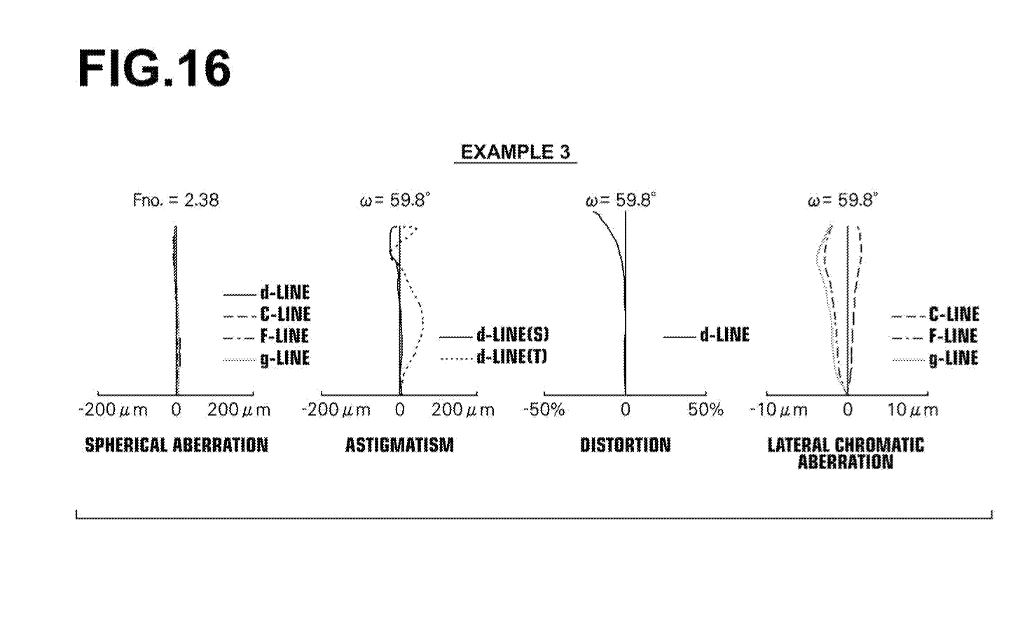

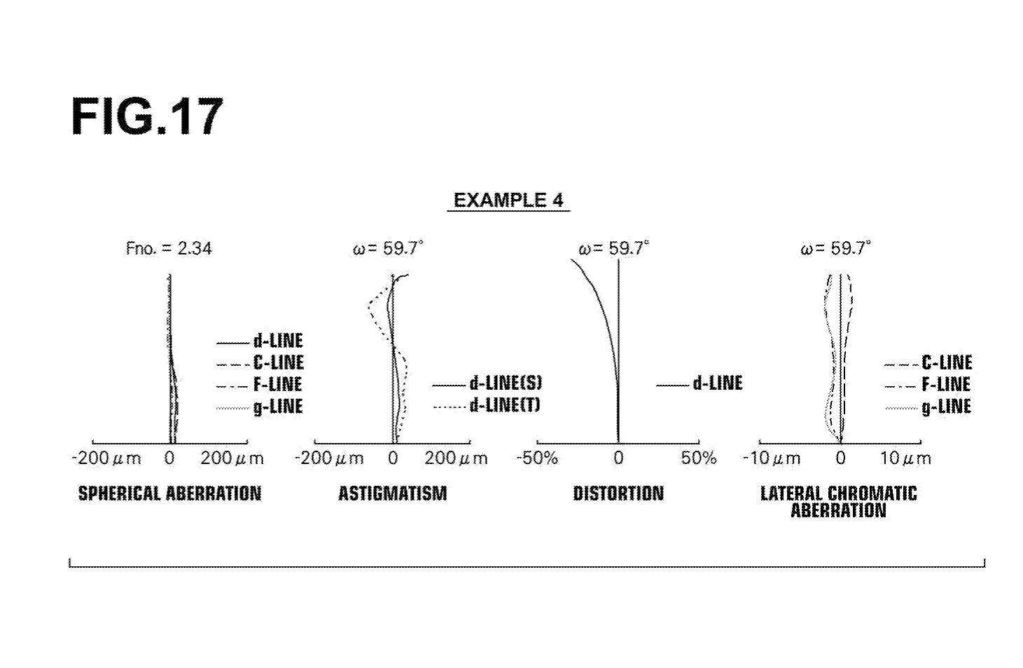

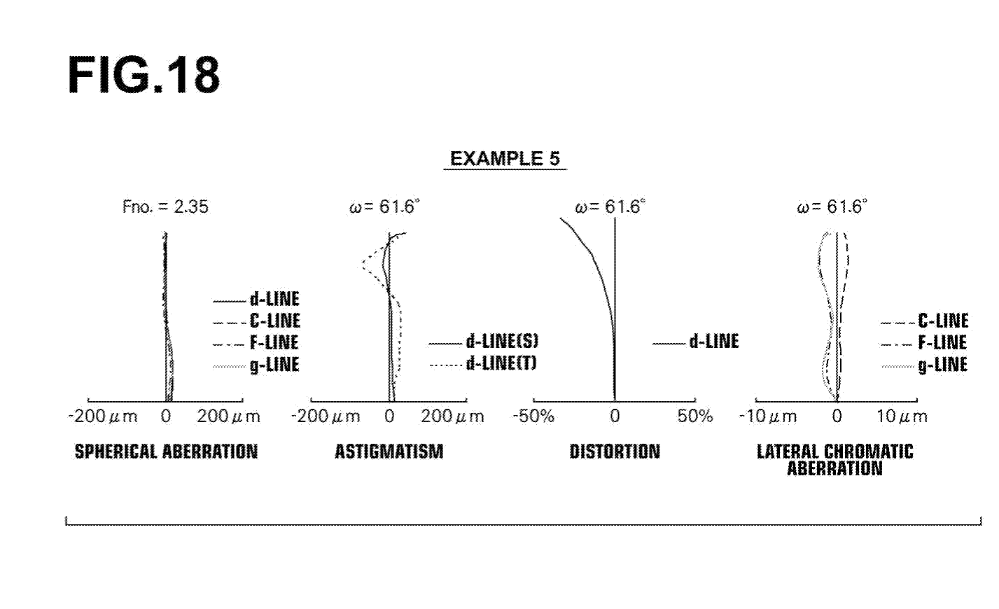

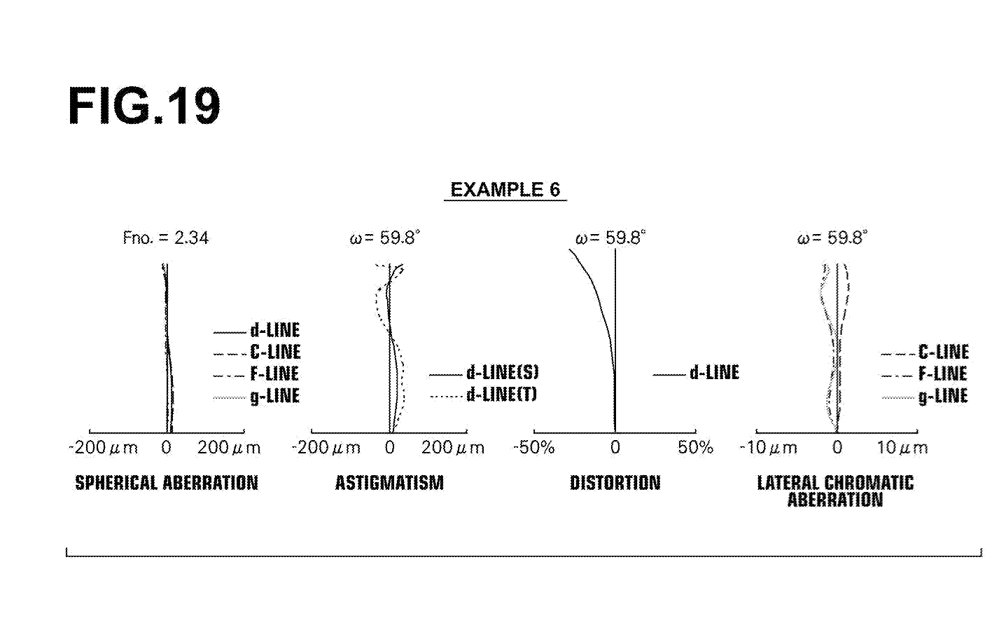

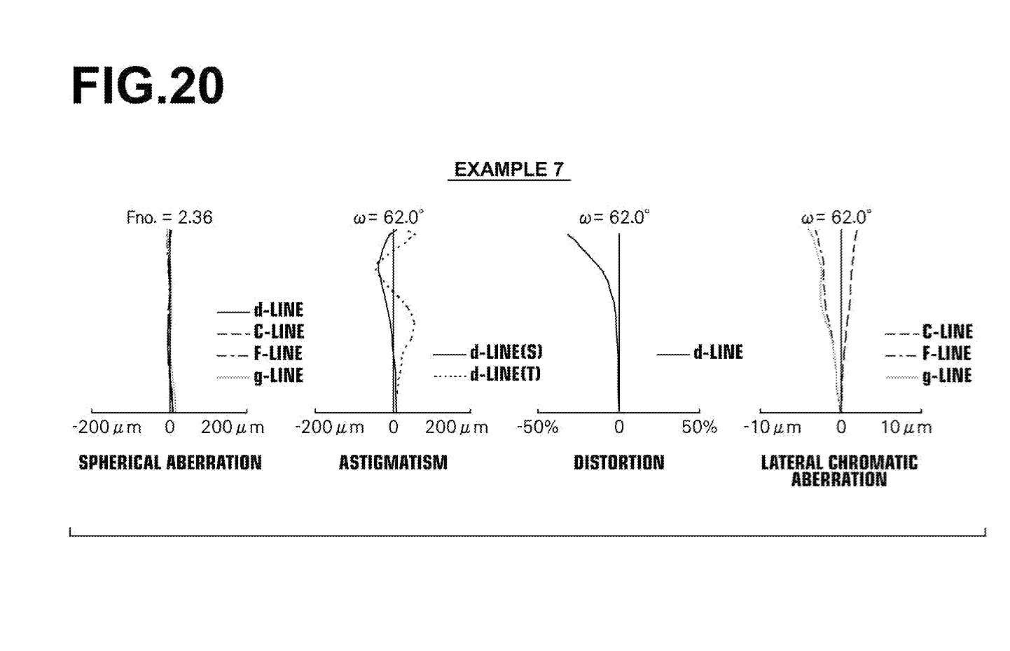

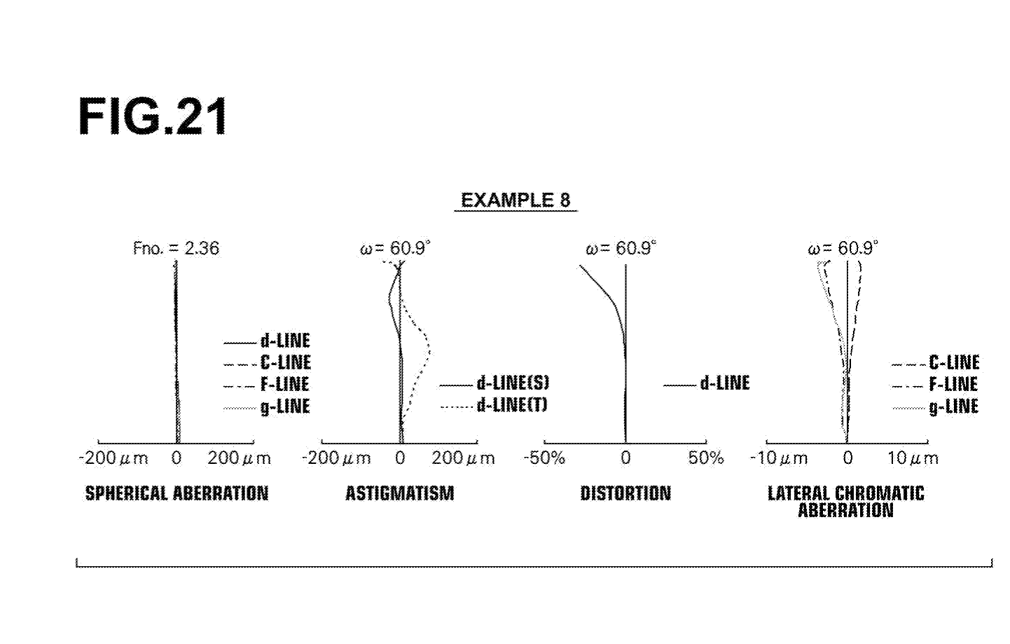

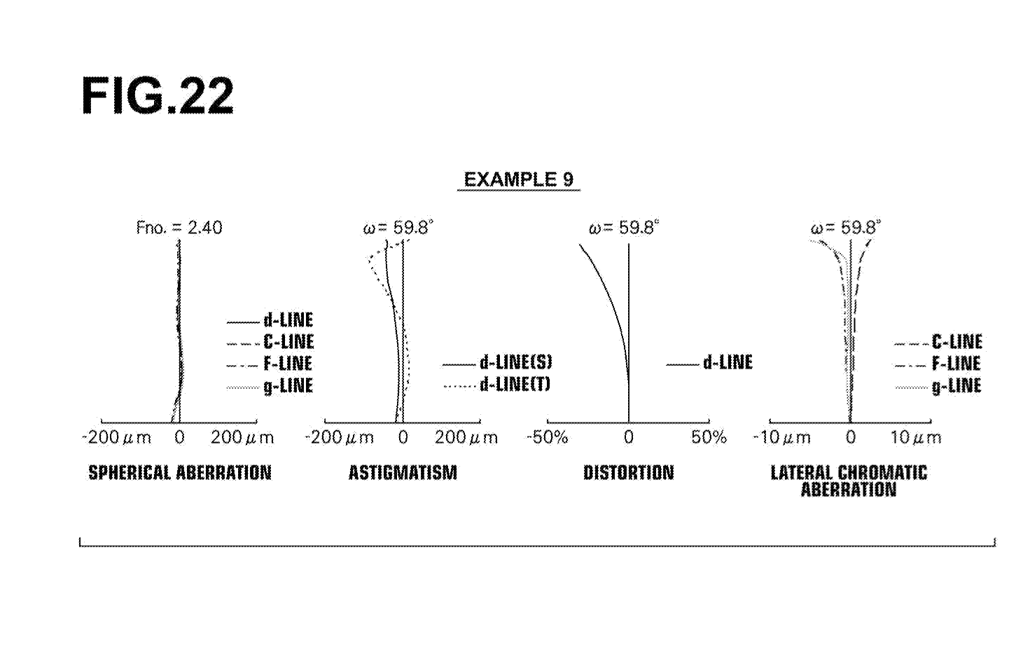

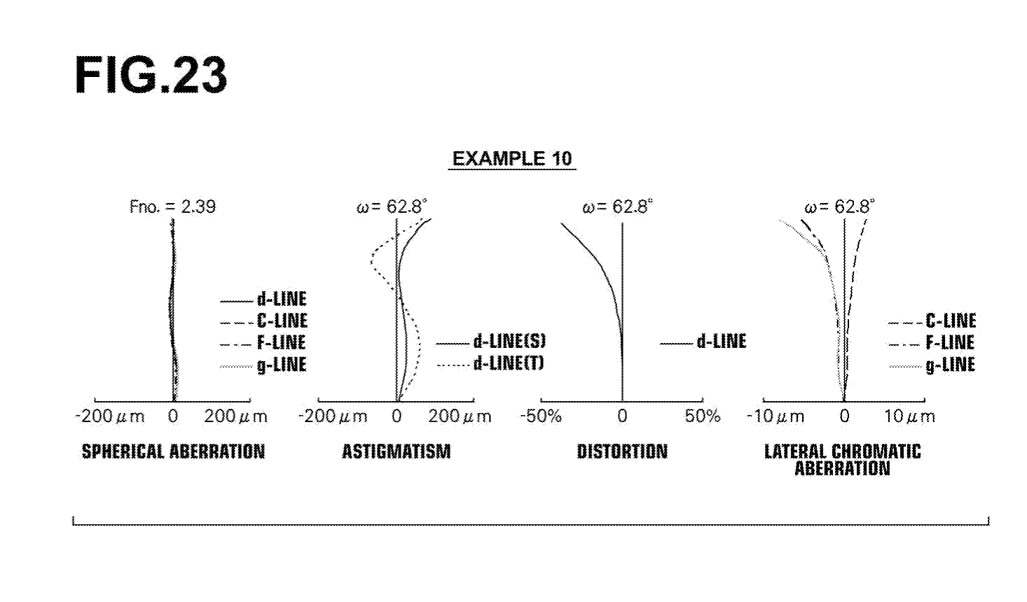

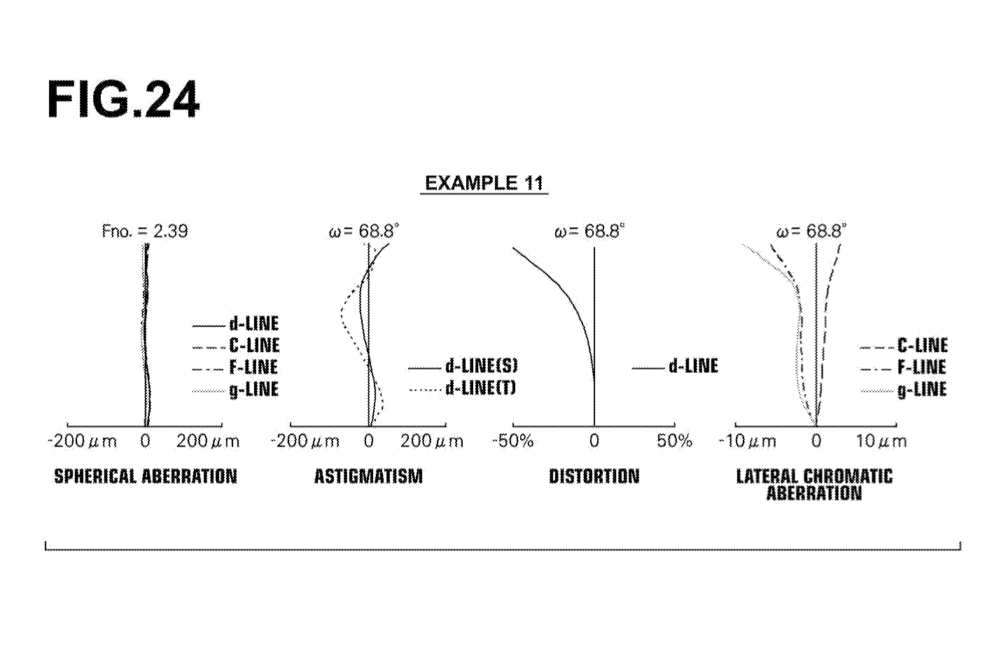

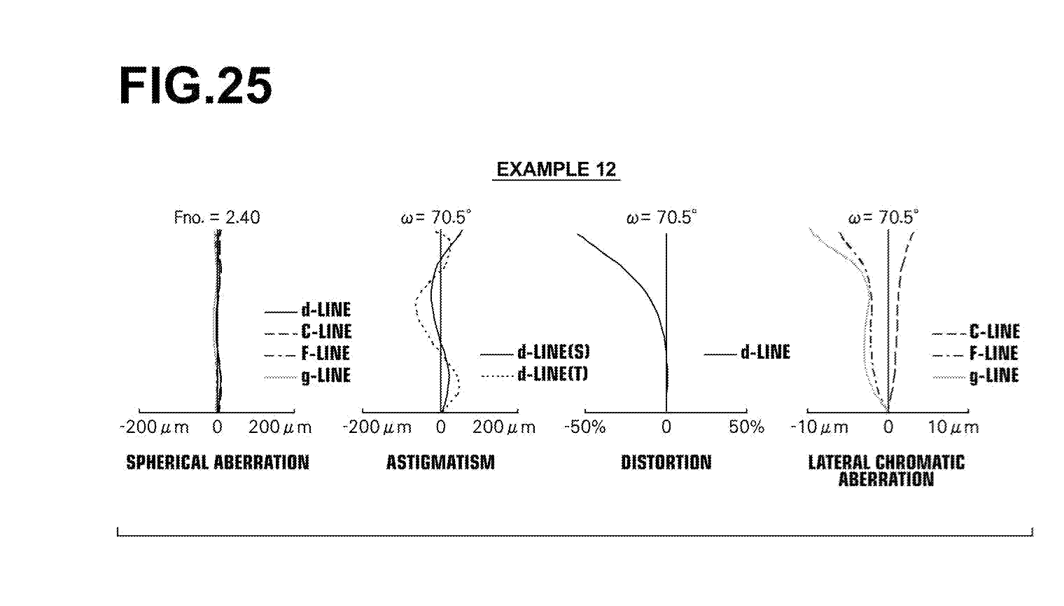

Likewise, various types of aberrations of the imaging lenses of Examples 2 to 12 are illustrated in FIG. 15 to FIG. 25. The aberration diagrams shown in FIG. 15 to FIG. 25 are all in the case where the object distance is infinity.

Table 25 summarizes the values of the conditional expressions (1) to (8) according to the present disclosure for each of Examples 1 to 12.

As is known from each numerical data and each aberration diagram, high imaging performance is realized in each example, even while realizing an increase in the angle of view and a reduction in the overall lens length.

It should be understood that the imaging lens of the present disclosure is not limited to the embodiments and each example described above, and various changes and modifications may be made. For example, values of radius of curvature, surface distance, refractive index, Abbe number, and aspherical surface coefficient of each lens component are not limited to those shown in each numerical example and may take other values.

Each example is described on the assumption that the imaging lens is used in fixed focus, but it is possible to take a configuration that allows focus adjustment. For example, it is possible to take a configuration that allows auto-focusing by, for example, paying out the entire lens system or moving some of the lenses on the optical axis.

TABLE 1
Example 1
f = 2.056, Bf = 0.895, Fno. = 2.37, 2ω = 123.8

| Si | Ri | Di | Ndj | νdj |
|---|---|---|---|---|
| *1 | −1.53916 | 0.268 | 1.54436 | 56.03 |
| *2 | −4.21317 | 0.059 | | |
| 3 (St) | ∞ | 0.009 | | |
| *4 | 2.05410 | 0.577 | 1.54436 | 56.03 |
| *5 | −3.37273 | 0.089 | | |
| *6 | 3.00310 | 0.460 | 1.54436 | 56.03 |
| *7 | −4.47471 | 0.379 | | |
| *8 | −0.56424 | 0.215 | 1.64176 | 22.46 |
| *9 | −1.23380 | 0.045 | | |
| *10 | −14.54842 | 0.520 | 1.54436 | 56.03 |
| *11 | −1.01698 | 0.045 | | |
| *12 | 1.09139 | 0.464 | 1.54436 | 56.03 |
| *13 | 0.74579 | 0.723 | | |
| 14 | ∞ | 0.210 | 1.51633 | 64.14 |
| 15 | ∞ | 0.024 | | |
| 16 (IMG) | ∞ | | | |

*Aspherical Surface

TABLE 2
Example 1 • Aspherical Surface Data

| Si | KA | A3 | A4 | A5 | A6 |
|---|---|---|---|---|---|
| 1 | −1.0324639E+00 | 0.0000000E+00 | 5.6477298E−02 | 1.2433555E+00 | −4.5038730E+00 |
| 2 | −4.2020648E−01 | 0.0000000E+00 | −5.3257034E−01 | 5.3620140E+00 | −2.4504903E+01 |
| 4 | −1.9603239E+01 | 0.0000000E+00 | −6.3316636E−01 | 4.8694500E+00 | −2.3592519E+01 |
| 5 | 6.0696737E−01 | 0.0000000E+00 | −5.6069145E−01 | −7.9877211E+00 | 3.9966870E+01 |
| 6 | 9.9028103E+00 | 0.0000000E+00 | −8.3554032E−01 | −3.2170484E+00 | 1.4073880E+01 |
| 7 | −2.2905773E+00 | 0.0000000E+00 | −1.6187945E−01 | −1.1312976E−01 | −5.0646999E−01 |
| 8 | −1.6585648E+00 | 0.0000000E+00 | −2.2092285E+00 | 1.3698463E+01 | −4.9539447E+01 |
| 9 | −2.9131275E+00 | 0.0000000E+00 | −9.1538586E−01 | 5.5398815E+00 | −1.7658976E+01 |
| 10 | −1.0543183E−01 | 0.0000000E+00 | 5.9264846E−01 | −5.0905867E+00 | 1.4133615E+01 |
| 11 | 2.8486385E−01 | 0.0000000E+00 | 6.9977402E−02 | −3.8018878E−01 | 1.3797406E+00 |
| 12 | 8.7269345E−02 | 0.0000000E+00 | −7.8334603E−01 | 6.7518464E−01 | 1.0833773E−01 |
| 13 | −2.8140493E+00 | 0.0000000E+00 | 3.0563187E−01 | −1.4091414E+00 | 2.1565722E+00 |
| | A7 | A8 | A9 | A10 | |
| 1 | 8.5950377E+00 | −9.9716618E+00 | 6.8172329E+00 | −2.1231386E+00 | |
| 2 | 6.6056223E+01 | −9.6074379E+01 | 6.7507260E+01 | −1.5067035E+01 | |
| 4 | 6.0335123E+01 | −8.2441452E+01 | 5.2083229E+01 | −8.9756880E+00 | |
| 5 | −9.1821593E+01 | 1.1671277E+02 | −7.9201172E+01 | 2.2699932E+01 | |
| 6 | −2.3522119E+01 | 1.8270548E+01 | −3.3523919E+00 | −1.7925994E+00 | |
| 7 | −1.7592305E−01 | 1.7446460E+00 | −1.8958269E+00 | 9.1618253E−01 | |
| 8 | 9.5051100E+01 | −9.7064205E+01 | 5.0946348E+01 | −1.0915936E+01 | |
| 9 | 2.9989185E+01 | −2.7001915E+01 | 1.2350553E+01 | −2.2624372E+00 | |
| 10 | −1.9143514E+01 | 1.4081015E+01 | −5.4212350E+00 | 8.4862085E−01 | |
| 11 | −1.3294212E+00 | 7.0700082E−01 | −3.2069346E−01 | 8.1703901E−02 | |
| 12 | −6.0341760E−01 | 4.4739498E−01 | −1.4142357E−01 | 1.6847189E−02 | |
| 13 | −1.7201459E+00 | 7.7564887E−01 | −1.8899271E−01 | 1.9449169E−02 | |

TABLE 3
Example 2
f = 2.251, Bf = 0.968, Fno. = 2.40, 2ω = 114.4

| Si | Ri | Di | Ndj | νdj |
|---|---|---|---|---|
| *1 | −1.14786 | 0.224 | 1.54436 | 56.03 |
| *2 | −2.53955 | 0.045 | | |
| 3 (St) | ∞ | 0.000 | | |
| *4 | 1.76631 | 0.761 | 1.54436 | 56.03 |
| *5 | −1.01473 | 0.074 | | |
| *6 | −17.25344 | 0.259 | 1.63351 | 23.63 |
| *7 | 4.47469 | 0.362 | | |
| *8 | −0.91892 | 0.268 | 1.63351 | 23.63 |
| *9 | −1.65928 | 0.045 | | |
| *10 | −2.41476 | 0.559 | 1.54436 | 56.03 |
| *11 | −1.06540 | 0.127 | | |
| *12 | 0.93505 | 0.358 | 1.54436 | 56.03 |
| *13 | 0.65173 | 0.723 | | |
| 14 | ∞ | 0.100 | 1.51633 | 64.14 |
| 15 | ∞ | 0.190 | | |
| 16 (IMG) | ∞ | | | |

*Aspherical Surface

TABLE 4
Example 2 • Aspherical Surface Data

| Si | KA | A3 | A4 | A5 | A6 |
|---|---|---|---|---|---|
| 1 | −1.0324639E+00 | 0.0000000E+00 | 1.9776337E−01 | 1.2013344E+00 | −5.0273968E+00 |
| 2 | −4.2020648E+01 | 0.0000000E+00 | −1.4902034E+00 | 8.2031705E+00 | −2.6691311E+01 |
| 4 | −1.9603239E+01 | 0.0000000E+00 | −1.1722054E+00 | 7.2328878E+00 | −2.7127344E+01 |
| 5 | 6.0696737E−01 | 0.0000000E+00 | 5.6397682E−01 | −9.0184610E+00 | 4.1217746E+01 |
| 6 | 9.9028103E+00 | 0.0000000E+00 | 2.0800907E−02 | −3.1219760E+00 | 1.2935468E+01 |
| 7 | −2.2905773E+00 | 0.0000000E+00 | 1.5657706E−01 | −4.5298258E−01 | 5.3505477E−01 |
| 8 | −1.6585648E+00 | 0.0000000E+00 | −9.2225488E−01 | 1.3169150E+01 | −5.0232584E+01 |
| 9 | −2.9131275E+00 | 0.0000000E+00 | −1.3674972E−01 | 5.1284381E+00 | −1.8651734E+01 |
| 10 | −1.0543183E−01 | 0.0000000E+00 | 1.3456460E+00 | −6.5229313E+00 | 1.4766420E+01 |
| 11 | 2.8486385E−01 | 0.0000000E+00 | 2.1615488E−02 | −5.1168965E−01 | 1.5584632E+00 |
| 12 | 8.7269345E−02 | 0.0000000E+00 | −1.0023288E+00 | 8.1133747E−01 | 2.4689184E−01 |
| 13 | −2.8140493E+00 | 0.0000000E+00 | 4.0905820E−01 | −1.7255078E+00 | 2.4923416E+00 |
| | A7 | A8 | A9 | A10 | |
| 1 | 9.2273035E+00 | −1.0008515E+01 | 6.3433308E+00 | −1.8015441E+00 | |
| 2 | 6.0050031E+01 | −8.7040780E+01 | 7.1468051E+01 | −2.4994288E+01 | |
| 4 | 5.9080537E+01 | −7.5661052E+01 | 4.8997834E+01 | −1.4086993E+01 | |
| 5 | −9.5623479E+01 | 1.1960164E+02 | −7.5789475E+01 | 1.8038686E+01 | |
| 6 | −2.3735846E+01 | 1.9142543E+01 | −3.1150656E+00 | −2.0960769E+00 | |
| 7 | −6.4626031E−01 | 1.1165481E+00 | −1.6604774E+00 | 1.0024846E+00 | |
| 8 | 9.4954508E+01 | −9.7077361E+01 | 5.1063730E+01 | −1.0808367E+01 | |
| 9 | 3.0662643E+01 | −2.6692509E+01 | 1.2071389E+01 | −2.2482357E+00 | |
| 10 | −1.8539452E+01 | 1.3600321E+01 | −5.4963161E+00 | 9.3966956E−01 | |
| 11 | −1.4655566E+00 | 7.5248191E−01 | −2.7759041E−01 | 5.5422369E−02 | |
| 12 | −7.7373362E−01 | 4.8207001E−01 | −1.2509967E−01 | 1.1364161E−02 | |
| 13 | −1.8617649E+00 | 7.7452323E−01 | −1.7138710E−01 | 1.5831881E−02 | |

TABLE 5
Example 3
f = 1.807, Bf = 0.788, Fno. = 2.38, 2ω = 119.6

| Si | Ri | Di | Ndj | νdj |
|---|---|---|---|---|
| *1 | −1.62672 | 0.443 | 1.54436 | 56.03 |
| *2 | −2.09920 | 0.045 | | |
| 3 (St) | ∞ | 0.000 | | |
| *4 | 2.44278 | 0.588 | 1.54436 | 56.03 |
| *5 | −1.04509 | 0.045 | | |
| *6 | −2.68915 | 0.251 | 1.63351 | 23.63 |
| *7 | −4.96277 | 0.401 | | |
| *8 | −0.54329 | 0.316 | 1.63351 | 23.63 |
| *9 | −1.14316 | 0.049 | | |
| *10 | −3.02799 | 0.448 | 1.54436 | 56.03 |
| *11 | −1.06541 | 0.054 | | |
| *12 | 0.76390 | 0.358 | 1.54436 | 56.03 |
| *13 | 0.69939 | 0.723 | | |
| 14 | ∞ | 0.100 | 1.51633 | 64.14 |
| 15 | ∞ | 0.000 | | |
| 16 (IMG) | ∞ | | | |

*Aspherical Surface

TABLE 6
Example 3 • Aspherical Surface Data

| Si | KA | A3 | A4 | A5 | A6 |
|---|---|---|---|---|---|
| 1 | −1.0324639E+00 | 0.0000000E+00 | −1.7945713E−01 | 1.5149131E+00 | −5.1402583E+00 |
| 2 | −4.2020648E+01 | 0.0000000E+00 | −1.4558489E+00 | 7.5172598E+00 | −2.7094238E+01 |
| 4 | −1.9603239E+01 | 0.0000000E+00 | −6.1900291E−01 | 4.2582148E+00 | −2.2157495E+01 |
| 5 | 6.0696737E−01 | 0.0000000E+00 | 1.4462819E+00 | −1.2743678E+01 | 4.5976062E+01 |
| 6 | 9.9028103E+00 | 0.0000000E+00 | 1.2081547E+00 | −5.0864518E+00 | 1.2720940E+01 |
| 7 | −2.2905773E+02 | 0.0000000E+00 | 1.8424785E−01 | 4.8895775E−01 | −8.5687907E−01 |
| 8 | −1.6585648E+00 | 0.0000000E+00 | −2.2761315E+00 | 1.5418181E+01 | −5.0711947E+01 |
| 9 | −2.9131275E+00 | 0.0000000E+00 | −5.0096488E−01 | 6.3533860E+00 | −1.9915714E+01 |
| 10 | −1.0543183E+02 | 0.0000000E+00 | 1.6828039E+00 | −7.2739396E+00 | 1.5021708E+01 |
| 11 | 2.8486385E−01 | 0.0000000E+00 | −5.3646539E−02 | −4.5504283E−01 | 1.6341874E+00 |
| 12 | 8.7269345E−02 | 0.0000000E+00 | −1.3275997E+00 | 1.1787100E+00 | 2.9230064E−01 |
| 13 | −2.8140493E+00 | 0.0000000E+00 | 2.5965763E−01 | −1.4361353E+00 | 2.3844701E+00 |
| | A7 | A8 | A9 | A10 | |
| 1 | 9.5683841E+00 | −1.0120324E+01 | 5.9526406E+00 | −1.5824039E+00 | |
| 2 | 6.3932153E+01 | −8.8013787E+01 | 6.6222530E+01 | −2.2625622E+01 | |
| 4 | 6.0781306E+01 | −8.7523872E+01 | 5.0717482E+01 | −5.8812132E+00 | |
| 5 | −9.7693862E+01 | 1.1828758E+02 | −7.1674120E+01 | 1.3969089E+01 | |
| 6 | −2.0927546E+01 | 1.8205400E+01 | −4.2086772E+00 | −1.3772831E+00 | |
| 7 | −1.4329310E+00 | 3.0883793E+00 | −1.4612156E+00 | 2.2773912E−01 | |
| 8 | 9.3158095E+01 | −9.5307920E+01 | 5.1519078E+01 | −1.1584891E+01 | |
| 9 | 2.9948196E+01 | −2.5356978E+01 | 1.2254917E+01 | −2.6693378E+00 | |
| 10 | −1.8318054E+01 | 1.3507031E+01 | −5.4973648E+00 | 9.3507062E−01 | |
| 11 | −1.3966359E+00 | 6.7333142E−01 | −3.0759582E−01 | 7.7861001E−02 | |
| 12 | −1.0076722E+00 | 5.5206771E−01 | −1.0518622E−01 | 3.1221350E−03 | |
| 13 | −1.9372332E+00 | 8.3436493E−01 | −1.8289244E−01 | 1.6076672E−02 | |

TABLE 7
Example 4
f = 2.048, Bf = 0.807, Fno. = 2.34, 2ω = 119.4

| Si | Ri | Di | Ndj | νdj |
|---|---|---|---|---|
| *1 | −1.23931 | 0.358 | 1.54436 | 56.03 |
| *2 | −29.81239 | 0.048 | | |
| 3 (St) | ∞ | 0.000 | | |
| *4 | 1.07204 | 0.895 | 1.54436 | 56.03 |
| *5 | −1.14115 | 0.045 | | |
| *6 | −27.35850 | 0.251 | 1.63351 | 23.63 |
| *7 | 6.70881 | 0.447 | | |
| *8 | −0.58065 | 0.269 | 1.63351 | 23.63 |
| *9 | −0.88640 | 0.049 | | |
| *10 | −4.52400 | 0.587 | 1.54436 | 56.03 |
| *11 | −1.07224 | 0.054 | | |
| *12 | 1.21484 | 0.358 | 1.54436 | 56.03 |
| *13 | 0.71558 | 0.723 | | |
| 14 | ∞ | 0.100 | 1.51633 | 64.14 |
| 15 | ∞ | 0.004 | | |
| 16 (IMG) | ∞ | | | |

*Aspherical Surface

TABLE 8
Example 4 • Aspherical Surface Data

| Si | KA | A3 | A4 | A5 | A6 |
|---|---|---|---|---|---|
| 1 | −1.0324639E+00 | 0.0000000E+00 | 9.1393017E−02 | 1.3307936E+00 | −5.0781884E+00 |
| 2 | −4.2020648E+01 | 0.0000000E+00 | −2.0753291E+00 | 9.5432855E+00 | −2.6865039E+01 |
| 4 | −1.9603239E+01 | 0.0000000E+00 | 1.2692236E−01 | 3.9738247E+00 | −2.4642678E+01 |
| 5 | 6.0696737E−01 | 0.0000000E+00 | 1.1571088E+00 | −1.1668479E+01 | 4.5116173E+01 |
| 6 | 9.9028103E+00 | 0.0000000E+00 | 5.0724944E−01 | −4.6812092E+00 | 1.3611734E+01 |
| 7 | −2.2905773E+02 | 0.0000000E+00 | 2.9003296E−01 | −3.6359275E−01 | −1.1987898E−01 |
| 8 | −1.6585648E+00 | 0.0000000E+00 | −1.3590274E+00 | 1.4902789E+01 | −5.2202557E+01 |
| 9 | −2.9131275E+00 | 0.0000000E+00 | 2.1707449E−02 | 6.1095827E+00 | −2.0453934E+01 |
| 10 | −1.0543183E+02 | 0.0000000E+00 | 1.6242600E+00 | −6.8313415E+00 | 1.4708031E+01 |
| 11 | 2.8486385E−01 | 0.0000000E+00 | 6.2229669E−02 | −4.5041457E−01 | 1.4261561E+00 |
| 12 | 8.7269345E−02 | 0.0000000E+00 | −7.3544966E−01 | 3.2662471E−01 | 5.8433690E−01 |
| 13 | −2.8140493E+00 | 0.0000000E+00 | 2.7753161E−01 | −1.6115315E+00 | 2.5468603E+00 |
| | A7 | A8 | A9 | A10 | |
| 1 | 9.3474606E+00 | −1.0150086E+01 | 6.2094395E+00 | −1.6573306E+00 | |
| 2 | 5.8697567E+01 | −8.6874181E+01 | 7.1454336E+01 | −2.4034884E+01 | |
| 4 | 6.3056250E+01 | −8.2155146E+01 | 4.8672851E+01 | −9.5571264E+00 | |
| 5 | −9.6091262E+01 | 1.1574873E+02 | −7.3415875E+01 | 1.8548627E+01 | |
| 6 | −2.1561937E+01 | 1.6310348E+01 | −3.9801025E+00 | −1.0378827E−01 | |
| 7 | −7.1475846E−01 | 1.8847670E+00 | −1.6191343E+00 | 7.4948493E−01 | |
| 8 | 9.3465259E+01 | −9.4070609E+01 | 5.1424436E+01 | −1.1967312E+01 | |
| 9 | 3.0133057E+01 | −2.5128672E+01 | 1.2198295E+01 | −2.7013651E+00 | |
| 10 | −1.8617351E+01 | 1.3741580E+01 | −5.4293320E+00 | 8.8238125E−01 | |
| 11 | −1.3786943E+00 | 7.6016176E−01 | −3.0654492E−01 | 6.3507454E−02 | |
| 12 | −8.1020631E−01 | 4.4491555E−01 | −1.1892773E−01 | 1.2687707E−02 | |
| 13 | −1.9788068E+00 | 8.2694991E−01 | −1.7681368E−01 | 1.5083449E−02 | |

TABLE 9
Example 5
f = 2.038, Bf = 0.855, Fno. = 2.35, 2ω = 123.2

| Si | Ri | Di | Ndj | νdj |
|---|---|---|---|---|
| *1 | −1.25272 | 0.358 | 1.54436 | 56.03 |
| *2 | −6.78893 | 0.045 | | |
| 3 (St) | ∞ | 0.000 | | |
| *4 | 1.26156 | 0.761 | 1.54436 | 56.03 |
| *5 | −1.00334 | 0.045 | | |
| *6 | −10.14035 | 0.251 | 1.63351 | 23.63 |
| *7 | 4.54149 | 0.420 | | |
| *8 | −0.69762 | 0.268 | 1.63351 | 23.63 |
| *9 | −1.01071 | 0.049 | | |
| *10 | −3.18413 | 0.559 | 1.54436 | 56.03 |
| *11 | −1.16181 | 0.054 | | |
| *12 | 1.07791 | 0.358 | 1.54436 | 56.03 |
| *13 | 0.71391 | 0.723 | | |
| 14 | ∞ | 0.100 | 1.51633 | 64.14 |
| 15 | ∞ | 0.050 | | |
| 16 (IMG) | ∞ | | | |

*Aspherical Surface

TABLE 10
Example 5 • Aspherical Surface Data

| Si | KA | A3 | A4 | A5 | A6 |
|---|---|---|---|---|---|
| 1 | −1.0324639E+00 | 0.0000000E+00 | 5.9482019E−02 | 1.2500507E+00 | −4.7834365E+00 |
| 2 | −4.2020648E+01 | 0.0000000E+00 | −1.8242767E+00 | 8.6958946E+00 | −2.5670501E+01 |
| 4 | −1.9603239E+01 | 0.0000000E+00 | −7.1735138E−01 | 6.5329415E+00 | −2.7262745E+01 |
| 5 | 6.0696737E−01 | 0.0000000E+00 | 8.9706704E−01 | −9.4397322E+00 | 4.0707733E+01 |
| 6 | 9.9028103E+00 | 0.0000000E+00 | 2.8042585E−01 | −3.1459113E+00 | 1.1910700E+01 |
| 7 | −2.2905773E+00 | 0.0000000E+00 | 4.3008451E−02 | 5.9172022E−02 | −5.5730847E−02 |
| 8 | −1.6585648E+00 | 0.0000000E+00 | −1.2526996E+00 | 1.4222249E+01 | −5.1098250E+01 |
| 9 | −2.9131275E+00 | 0.0000000E+00 | 3.4247692E−02 | 5.6418224E+00 | −1.9742837E+01 |
| 10 | −1.0543183E−01 | 0.0000000E+00 | 1.9336125E+00 | −7.1656085E+00 | 1.4561147E+01 |
| 11 | 2.8486385E−01 | 0.0000000E+00 | 7.2252439E−02 | −5.6272510E−01 | 1.6164621E+00 |
| 12 | 8.7269345E−02 | 0.0000000E+00 | −7.4598168E−01 | 3.8429881E−01 | 4.1939878E−01 |
| 13 | −2.8140493E+00 | 0.0000000E+00 | 4.5290158E−01 | −1.8748222E+00 | 2.6471120E+00 |
| | A7 | A8 | A9 | A10 | |
| 1 | 9.0881337E+00 | −1.0211490E+01 | 6.4497624E+00 | −1.7647390E+00 | |
| 2 | 5.7917014E+01 | −8.7260406E+01 | 7.3274364E+01 | −2.5410215E+01 | |
| 4 | 6.0620430E+01 | −7.6378184E+01 | 4.8099986E+01 | −1.3579529E+01 | |
| 5 | −9.5159214E+01 | 1.2051273E+02 | −7.6160129E+01 | 1.7451774E+01 | |
| 6 | −2.3641700E+01 | 2.0521170E+01 | −3.1811399E+00 | −2.7189092E+00 | |
| 7 | −1.1176821E+00 | 1.9614157E+00 | −1.5078967E+00 | 6.9005128E−01 | |
| 8 | 9.4117567E+01 | −9.5822049E+01 | 5.1272896E+01 | −1.1266711E+01 | |
| 9 | 3.0259362E+01 | −2.5607151E+01 | 1.2168558E+01 | −2.5742093E+00 | |
| 10 | −1.8155436E+01 | 1.3608783E+01 | −5.5612424E+00 | 9.4468820E−01 | |
| 11 | −1.4563829E+00 | 7.2040325E−01 | −2.7560500E−01 | 5.9563977E−02 | |
| 12 | −6.9187639E−01 | 4.3071478E−01 | −1.3058365E−01 | 1.5698737E−02 | |
| 13 | −1.9328001E+00 | 7.8146693E−01 | −1.6564404E−01 | 1.4368809E−02 | |

TABLE 11
Example 6
f = 2.030, Bf = 0.817, Fno. = 2.34, 2ω = 119.6

| Si | Ri | Di | Ndj | νdj |
|---|---|---|---|---|
| *1 | −1.21937 | 0.358 | 1.54436 | 56.03 |
| *2 | −14.30650 | 0.049 | | |
| 3 (St) | ∞ | 0.000 | | |
| *4 | 1.07305 | 0.895 | 1.54436 | 56.03 |
| *5 | −1.22440 | 0.045 | | |
| *6 | −27.28310 | 0.251 | 1.63351 | 23.63 |
| *7 | 26.48095 | 0.393 | | |
| *8 | −0.59905 | 0.269 | 1.63351 | 23.63 |
| *9 | −1.12904 | 0.049 | | |
| *10 | −6.10093 | 0.581 | 1.54436 | 56.03 |
| *11 | −1.06541 | 0.054 | | |
| *12 | 1.02340 | 0.358 | 1.54436 | 56.03 |
| *13 | 0.66249 | 0.723 | | |
| 14 | ∞ | 0.100 | 1.51633 | 64.14 |
| 15 | ∞ | 0.015 | | |
| 16 (IMG) | ∞ | | | |

*Aspherical Surface

TABLE 12
Example 6 • Aspherical Surface Data

| Si | KA | A3 | A4 | A5 | A6 |
|---|---|---|---|---|---|
| 1 | −1.0324639E+00 | 0.0000000E+00 | 9.2063671E−02 | 1.3248162E+00 | −5.0747054E+00 |
| 2 | −4.2020648E+01 | 0.0000000E+00 | −2.1591249E+00 | 9.7243996E+00 | −2.6722957E+01 |
| 4 | −1.9603239E+01 | 0.0000000E+00 | 8.8017284E−02 | 3.8712643E+00 | −2.4233900E+01 |
| 5 | 6.0696737E−01 | 0.0000000E+00 | 1.0072023E+00 | −1.2034385E+01 | 4.5995450E+01 |
| 6 | 9.9028103E+00 | 0.0000000E+00 | 4.9226005E−01 | −4.8196941E+00 | 1.3683462E+01 |
| 7 | −2.2905773E+02 | 0.0000000E+00 | 3.2208319E−01 | −9.3699879E−02 | −6.3564089E−01 |
| 8 | −1.6585648E+00 | 0.0000000E+00 | −1.3871328E+00 | 1.5037802E+01 | −5.2262045E+01 |
| 9 | −2.9131275E+00 | 0.0000000E+00 | 9.1588668E−02 | 5.9648571E+00 | −2.0409499E+01 |
| 10 | −1.0543183E+02 | 0.0000000E+00 | 1.7395512E+00 | −7.0091398E+00 | 1.4708101E+01 |
| 11 | 2.8486385E−01 | 0.0000000E+00 | 1.5492969E−01 | −6.2269520E−01 | 1.4871811E+00 |
| 12 | 8.7269345E−02 | 0.0000000E+00 | −9.7463496E−01 | 5.4951105E−01 | 5.5644800E−01 |
| 13 | −2.8140493E+00 | 0.0000000E+00 | 2.4598886E−01 | −1.5698807E+00 | 2.5325931E+00 |
| | A7 | A8 | A9 | A10 | |
| 1 | 9.4306905E+00 | −1.0252533E+01 | 6.1524256E+00 | −1.5687373E+00 | |
| 2 | 5.8246405E+01 | −8.7300985E+01 | 7.1883167E+01 | −2.3377994E+01 | |
| 4 | 6.3404306E+01 | −8.4273822E+01 | 4.8854388E+01 | −7.7547142E+00 | |
| 5 | −9.5899387E+01 | 1.1467801E+02 | −7.3471516E+01 | 1.9019977E+01 | |
| 6 | −2.1277154E+01 | 1.5943645E+01 | −4.0730670E+00 | 2.2286082E−01 | |
| 7 | −9.5732558E−01 | 2.6252362E+00 | −1.5696740E+00 | 4.4153843E−01 | |
| 8 | 9.3353957E+01 | −9.3905813E+01 | 5.1446621E+01 | −1.2058406E+01 | |
| 9 | 3.0174082E+01 | −2.5114268E+01 | 1.2208177E+01 | −2.7301358E+00 | |
| 10 | −1.8543798E+01 | 1.3747770E+01 | −5.4440708E+00 | 8.7894658E−01 | |
| 11 | −1.2880152E+00 | 7.0776710E−01 | −3.2902634E−01 | 7.7508240E−02 | |
| 12 | −8.5068518E−01 | 4.5711884E−01 | −1.1684719E−01 | 1.1816483E−02 | |
| 13 | −1.9850260E+00 | 8.2890390E−01 | −1.7446654E−01 | 1.4281575E−02 | |

TABLE 13
Example 7
f = 1.940, Bf = 0.813, Fno. = 2.36, 2ω = 124.0

| Si | Ri | Di | Ndj | νdj |
|---|---|---|---|---|
| *1 | −1.30405 | 0.399 | 1.54436 | 56.03 |
| *2 | −10.37878 | 0.045 | | |
| 3 (St) | ∞ | 0.000 | | |
| *4 | 1.26002 | 0.828 | 1.54436 | 56.03 |
| *5 | −0.87961 | 0.052 | | |
| *6 | −2.68829 | 0.251 | 1.63351 | 23.63 |
| *7 | −4.73810 | 0.363 | | |
| *8 | −0.71060 | 0.313 | 1.63351 | 23.63 |
| *9 | −2.39763 | 0.049 | | |
| *10 | −2.95091 | 0.556 | 1.54436 | 56.03 |
| *11 | −1.39482 | 0.054 | | |
| *12 | 0.71247 | 0.366 | 1.54436 | 56.03 |
| *13 | 0.74586 | 0.723 | | |
| 14 | ∞ | 0.100 | 1.51633 | 64.14 |
| 15 | ∞ | 0.015 | | |
| 16 (IMG) | ∞ | | | |

*Aspherical Surface

TABLE 14
Example 7 • Aspherical Surface Data

| Si | KA | A3 | A4 | A5 | A6 |
|---|---|---|---|---|---|
| 1 | −1.0324639E+00 | 0.0000000E+00 | 1.0331097E−01 | 1.3102532E+00 | −5.2655743E+00 |
| 2 | −4.2020648E+01 | 0.0000000E+00 | −1.5015868E+00 | 8.4495335E+00 | −2.7349985E+01 |
| 4 | −1.9603239E+01 | 0.0000000E+00 | −1.0759970E−01 | 3.5585557E+00 | −2.2100631E+01 |
| 5 | 6.0696737E−01 | 0.0000000E+00 | 1.3552621E+00 | −1.1098776E+01 | 4.4157282E+01 |
| 6 | 9.9028103E+00 | 0.0000000E+00 | 8.8570402E−01 | −5.0175112E+00 | 1.3532524E+01 |
| 7 | −2.2905773E+02 | 0.0000000E+00 | −3.2118968E−01 | 4.2924636E−01 | −1.2101091E−01 |
| 8 | −1.6585648E+00 | 0.0000000E+00 | −2.3484736E+00 | 1.5081463E+01 | −5.0048324E+01 |
| 9 | −2.9131275E+00 | 0.0000000E+00 | −9.5800380E−01 | 6.3494219E+00 | −1.8859211E+01 |
| 10 | −1.0543183E+02 | 0.0000000E+00 | 1.3620273E+00 | −7.1080594E+00 | 1.5335069E+01 |
| 11 | 2.8486385E−01 | 0.0000000E+00 | −2.3625182E−01 | −3.5873269E−01 | 1.6374854E+00 |
| 12 | 8.7269345E−02 | 0.0000000E+00 | −1.2946600E+00 | 9.0499716E−01 | 4.7013152E−01 |
| 13 | −2.8140493E+00 | 0.0000000E+00 | 3.7294975E−01 | −1.6948711E+00 | 2.4975522E+00 |
| | A7 | A8 | A9 | A10 | |
| 1 | 9.9245192E+00 | −1.0426413E+01 | 5.7968281E+00 | −1.3323569E+00 | |
| 2 | 6.2076551E+01 | −8.7881482E+01 | 6.7739727E+01 | −2.2273301E+01 | |
| 4 | 6.2396646E+01 | −8.8430478E+01 | 4.9534869E+01 | −5.2886582E+00 | |
| 5 | −9.9551367E+01 | 1.2180604E+02 | −7.0886348E+01 | 1.2233644E+01 | |
| 6 | −2.0926089E+01 | 1.6847629E+01 | −4.2775862E+00 | −6.3317518E−01 | |
| 7 | −1.2490735E+00 | 2.6159044E+00 | −1.5216723E+00 | 3.3969983E−01 | |
| 8 | 9.3362906E+01 | −9.6083537E+01 | 5.1482393E+01 | −1.1333007E+01 | |
| 9 | 2.9980477E+01 | −2.6215807E+01 | 1.2228280E+01 | −2.4383946E+00 | |
| 10 | −1.8433807E+01 | 1.3353510E+01 | −5.4706138E+00 | 9.6524212E−01 | |
| 11 | −1.4468082E+00 | 6.8333893E−01 | −2.9828328E−01 | 7.7671141E−02 | |
| 12 | −9.4299384E−01 | 4.9586543E−01 | −1.0981162E−01 | 8.0823592E−03 | |
| 13 | −1.8892268E+00 | 8.0557639E−01 | −1.8685730E−01 | 1.8539980E−02 | |

TABLE 15
Example 8
f = 1.942, Bf = 0.853, Fno. = 2.36, 2ω = 121.8

| Si | Ri | Di | Ndj | νdj |
|---|---|---|---|---|
| *1 | −1.26891 | 0.358 | 1.54436 | 56.03 |
| *2 | −6.79482 | 0.045 | | |
| 3 (St) | ∞ | 0.000 | | |
| *4 | 1.28757 | 0.847 | 1.54436 | 56.03 |
| *5 | −0.96259 | 0.045 | | |
| *6 | −3.22221 | 0.251 | 1.63351 | 23.63 |
| *7 | −4.71360 | 0.407 | | |
| *8 | −0.57807 | 0.269 | 1.63351 | 23.63 |
| *9 | −1.45984 | 0.054 | | |
| *10 | −2.51541 | 0.502 | 1.54436 | 56.03 |
| *11 | −1.35093 | 0.054 | | |
| *12 | 0.68628 | 0.358 | 1.54436 | 56.03 |
| *13 | 0.76395 | 0.723 | | |
| 14 | ∞ | 0.100 | 1.51633 | 64.14 |
| 15 | ∞ | 0.055 | | |
| 16 (IMG) | ∞ | | | |

*Aspherical Surface

TABLE 16
Example 8 • Aspherical Surface Data

| Si | KA | A3 | A4 | A5 | A6 |
|---|---|---|---|---|---|
| 1 | −1.0324639E+00 | 0.0000000E+00 | 5.5824380E−02 | 1.5383808E+00 | −5.4710331E+00 |
| 2 | −4.2020648E+01 | 0.0000000E+00 | −1.4663755E+00 | 8.3539386E+00 | −2.7467646E+01 |
| 4 | −1.9603239E+01 | 0.0000000E+00 | −1.5811026E−01 | 3.7862463E+00 | −2.2555482E+01 |
| 5 | 6.0696737E−01 | 0.0000000E+00 | 1.2321057E+00 | −1.1552019E+01 | 4.5049708E+01 |
| 6 | 9.9028103E+00 | 0.0000000E+00 | 7.3020006E−01 | −4.6433671E+00 | 1.3301833E+01 |
| 7 | −2.2905773E+02 | 0.0000000E+00 | −1.2808584E−01 | 4.2759041E−01 | −2.1405202E−01 |
| 8 | −1.6585648E+00 | 0.0000000E+00 | −2.2152100E+00 | 1.5165138E+01 | −5.0370093E+01 |
| 9 | −2.9131275E+00 | 0.0000000E+00 | −4.9653415E−01 | 6.2169962E+00 | −1.9701484E+01 |
| 10 | −1.0543183E+02 | 0.0000000E+00 | 1.5853073E+00 | −7.1436567E+00 | 1.4996853E+01 |
| 11 | 2.8486385E−01 | 0.0000000E+00 | −1.8270887E−01 | −5.8321982E−01 | 1.8288828E+00 |
| 12 | 8.7269345E−02 | 0.0000000E+00 | −1.3654200E+00 | 8.9291840E−01 | 5.0717993E−01 |
| 13 | −2.8140493E+00 | 0.0000000E+00 | 3.4970640E−01 | −1.6964780E+00 | 2.5057933E+00 |
| | A7 | A8 | A9 | A10 | |
| 1 | 9.5961754E+00 | −9.9448928E+00 | 5.9372807E+00 | −1.6108822E+00 | |
| 2 | 6.2316437E+01 | −8.7791718E+01 | 6.7678025E+01 | −2.2217594E+01 | |
| 4 | 6.2376949E+01 | −8.7419631E+01 | 4.9643331E+01 | −5.8990806E+00 | |
| 5 | −9.8373996E+01 | 1.1893923E+02 | −7.1491693E+01 | 1.4764363E+01 | |
| 6 | −2.1692471E+01 | 1.7166404E+01 | −3.8779810E+00 | −7.1861533E−01 | |
| 7 | −1.3645691E+00 | 2.4509923E+00 | −1.4772391E+00 | 4.4273793E−01 | |
| 8 | 9.3256616E+01 | −9.5742894E+01 | 5.1508283E+01 | −1.1453211E+01 | |
| 9 | 3.0120370E+01 | −2.5647564E+01 | 1.2191456E+01 | −2.5736525E+00 | |
| 10 | −1.8425045E+01 | 1.3594396E+01 | −5.4772506E+00 | 9.0678716E−01 | |
| 11 | −1.3262966E+00 | 5.6823778E−01 | −3.1939806E−01 | 9.6031169E−02 | |
| 12 | −9.4124291E−01 | 4.9020376E−01 | −1.0993748E−01 | 8.2535426E−03 | |
| 13 | −1.8885727E+00 | 8.0488653E−01 | −1.8694758E−01 | 1.8554307E−02 | |

TABLE 17
Example 9
f = 2.072, Bf = 0.915, Fno. = 2.40, 2ω = 119.6

| Si | Ri | Di | Ndj | νdj |
|---|---|---|---|---|
| *1 | −1.81697 | 0.358 | 1.54436 | 56.03 |
| *2 | −20.16695 | 0.045 | | |
| 3 (St) | ∞ | 0.000 | | |
| *4 | 1.54421 | 0.625 | 1.54436 | 56.03 |
| *5 | −4.25063 | 0.045 | | |
| *6 | 3.16565 | 0.403 | 1.54436 | 56.03 |
| *7 | −4.69011 | 0.287 | | |
| *8 | −0.85093 | 0.224 | 1.64176 | 22.46 |
| *9 | −2.86091 | 0.049 | | |
| *10 | −9.06319 | 0.559 | 1.54436 | 56.03 |
| *11 | −1.01698 | 0.095 | | |
| *12 | 1.17475 | 0.492 | 1.54436 | 56.03 |
| *13 | 0.77377 | 0.723 | | |
| 14 | ∞ | 0.100 | 1.51633 | 64.14 |
| 15 | ∞ | 0.144 | | |
| 16 (IMG) | ∞ | | | |

*Aspherical Surface

TABLE 18
Example 9 • Aspherical Surface Data

| Si | KA | A3 | A4 | A5 | A6 |
|---|---|---|---|---|---|
| 1 | −1.0324639E+00 | 0.0000000E+00 | −5.8303006E−02 | 1.2086896E+00 | −4.4432327E+00 |
| 2 | −4.2020648E−01 | 0.0000000E+00 | −1.5055649E+00 | 6.9286830E+00 | −2.4649926E+01 |
| 4 | −1.9603239E+01 | 0.0000000E+00 | −1.1358628E+00 | 7.1159287E+00 | −2.6470423E+01 |
| 5 | 6.0696737E−01 | 0.0000000E+00 | 5.3113178E−01 | −1.0073289E+01 | 4.0371677E+01 |
| 6 | 9.9028103E+00 | 0.0000000E+00 | 1.7586748E−01 | −4.4479884E+00 | 1.3698288E+01 |
| 7 | −2.2905773E+00 | 0.0000000E+00 | 1.7904742E−01 | −1.5400043E−01 | −7.7696830E−01 |
| 8 | −1.6585648E+00 | 0.0000000E+00 | −1.3808820E+00 | 1.3094542E+01 | −5.0179346E+01 |
| 9 | −2.9131275E+00 | 0.0000000E+00 | −8.7905540E−01 | 6.0937007E+00 | −1.8353761E+01 |
| 10 | −1.0543183E−01 | 0.0000000E+00 | 4.3913972E−01 | −4.7508667E+00 | 1.4079153E+01 |
| 11 | 2.8486385E−01 | 0.0000000E+00 | −5.1372140E−02 | −3.6252430E−01 | 1.3822959E+00 |
| 12 | 8.7269345E−02 | 0.0000000E+00 | −7.2227111E−01 | 5.1801553E−01 | 2.8616671E−01 |
| 13 | −2.8140493E+00 | 0.0000000E+00 | 3.7825288E−01 | −1.6339539E+00 | 2.4073320E+00 |
| | A7 | A8 | A9 | A10 | |
| 1 | 8.9949922E+00 | −1.0570201E+01 | 6.5741503E+00 | −1.6299391E+00 | |
| 2 | 6.4005459E+01 | −9.5925221E+01 | 6.8573010E+01 | −1.5521994E+01 | |
| 4 | 5.8471066E+01 | −7.6101469E+01 | 5.1233892E+01 | −1.3577983E+01 | |
| 5 | −8.9778746E+01 | 1.1583899E+02 | −8.0178649E+01 | 2.2984750E+01 | |
| 6 | −2.2034969E+01 | 1.7362392E+01 | −3.9353539E+00 | −1.0555137E+00 | |
| 7 | −2.5641919E−01 | 1.9672923E+00 | −1.8702292E+00 | 8.1158712E−01 | |
| 8 | 9.5434268E+01 | −9.6885544E+01 | 5.0864584E+01 | −1.0916304E+01 | |
| 9 | 2.9842924E+01 | −2.6638067E+01 | 1.2306646E+01 | −2.3106566E+00 | |
| 10 | −1.9538068E+01 | 1.4320372E+01 | −5.3276795E+00 | 7.6746751E−01 | |
| 11 | −1.4348170E+00 | 8.7096417E−01 | −2.9405083E−01 | 3.2341995E−02 | |
| 12 | −6.7217511E−01 | 4.4110959E−01 | −1.3189524E−01 | 1.5267040E−02 | |
| 13 | −1.8381930E+00 | 7.8173050E−01 | −1.7628044E−01 | 1.6484472E−02 | |

TABLE 19
Example 10
f = 2.066, Bf = 1.265, Fno. = 2.39 2ω = 125.6

| Si | Ri | Di | Ndj | νdj |
|---|---|---|---|---|
| *1 | −1.49157 | 0.358 | 1.54436 | 56.03 |
| *2 | −3.07463 | 0.112 | | |
| 3 (St) | ∞ | 0.009 | | |
| *4 | 3.67962 | 0.600 | 1.54436 | 56.03 |
| *5 | −2.27533 | 0.089 | | |
| *6 | 2.98566 | 0.470 | 1.54436 | 56.03 |
| *7 | −4.47471 | 0.273 | | |
| *8 | −0.51917 | 0.215 | 1.64176 | 22.46 |
| *9 | −1.08557 | 0.045 | | |
| *10 | −3.62284 | 0.461 | 1.54436 | 56.03 |
| *11 | −1.11196 | 0.045 | | |
| *12 | 1.09139 | 0.434 | 1.54436 | 56.03 |
| *13 | 1.06048 | 0.723 | | |
| 14 | ∞ | 0.210 | 1.51633 | 64.14 |
| 15 | ∞ | 0.395 | | |
| 16 (IMG) | ∞ | | | |

*Aspherical Surface

TABLE 20
Example 10 • Aspherical Surface Data

| Si | KA | A3 | A4 | A5 | A6 |
|---|---|---|---|---|---|
| 1 | −1.0324639E+00 | 0.0000000E+00 | 2.6128193E+01 | 1.1669648E+00 | −4.7728481E+00 |
| 2 | −4.2020648E+01 | 0.0000000E+00 | 3.4969476E+01 | 5.4257395E+00 | −2.7240805E+01 |
| 4 | −1.9603239E+01 | 0.0000000E+00 | 1.9880882E+01 | 3.5178536E+00 | −2.3809546E+01 |
| 5 | 6.0696737E+01 | 0.0000000E+00 | 6.0097237E+02 | −8.9503457E+00 | 3.9851896E+01 |
| 6 | 9.9028103E+00 | 0.0000000E+00 | −3.9995460E+01 | −3.0559388E+00 | 1.2823033E+01 |
| 7 | −2.2905773E+00 | 0.0000000E+00 | 1.8179611E+01 | −6.7338061E+02 | −7.6872162E+01 |
| 8 | −1.6585648E+00 | 0.0000000E+00 | −1.5145542E+00 | 1.3661982E+01 | −5.0590160E+01 |
| 9 | −2.9131275E+00 | 0.0000000E+00 | −2.5312867E+01 | 5.4859596E+00 | −1.8919284E+01 |
| 10 | −1.0543183E+01 | 0.0000000E+00 | 8.6701991E+01 | −5.1112249E+00 | 1.3782066E+01 |
| 11 | 2.8486385E+01 | 0.0000000E+00 | −1.3274369E+01 | −4.2056753E+01 | 1.6774021E+00 |
| 12 | 8.7269345E+02 | 0.0000000E+00 | −7.2787452E+01 | 5.5507716E+01 | 1.4216931E+01 |
| 13 | −2.8140493E+00 | 0.0000000E+00 | 2.2439921E+01 | −1.3440652E+00 | 2.1379860E+00 |
| | A7 | A8 | A9 | A10 | |
| 1 | 8.6730965E+00 | −9.9154391E+00 | 6.8023443E+00 | −2.0579143E+00 | |
| 2 | 6.6247017E+01 | −9.1854967E+01 | 6.7393055E+01 | −1.7487308E+01 | |
| 4 | 6.2276300E+01 | −8.2969919E+01 | 5.1043103E+01 | −8.6185274E+00 | |
| 5 | −9.0123556E+01 | 1.1538259E+02 | −8.0090445E+01 | 2.3907122E+01 | |
| 6 | −2.3779653E+01 | 1.9673525E+01 | −3.2392480E+00 | −2.3686097E+00 | |
| 7 | −2.7291344E+01 | 1.5801825E+00 | −1.8575206E+00 | 1.0590337E+00 | |
| 8 | 9.5025249E+01 | −9.6463252E+01 | 5.0963964E+01 | −1.1036129E+01 | |
| 9 | 3.0099543E+01 | −2.6046954E+01 | 1.2306652E+01 | −2.5126407E+00 | |
| 10 | −1.9090225E+01 | 1.4299386E+01 | −5.4368690E+00 | 8.0155312E+01 | |
| 11 | −1.3164479E+00 | 6.0238537E+01 | −3.2725581E+01 | 9.2051414E+02 | |
| 12 | −5.6479175E+01 | 4.3344752E+01 | −1.4469053E+01 | 1.7867488E+02 | |
| 13 | −1.7179942E+00 | 7.7650333E+01 | −1.9016134E+01 | 1.9764179E+02 | |

TABLE 21
Example 11
f = 1.954, Bf = 1.287, Fno. = 2.39, 2ω = 137.6

| Si | Ri | Di | Ndj | νdj |
|---|---|---|---|---|
| *1 | −1.90929 | 0.358 | 1.54436 | 56.03 |
| *2 | 44.48239 | 0.134 | | |
| 3 (St) | ∞ | 0.009 | | |
| *4 | 3.17230 | 0.600 | 1.54436 | 56.03 |
| *5 | −2.28975 | 0.089 | | |
| *6 | 3.10837 | 0.470 | 1.54436 | 56.03 |
| *7 | −2.24038 | 0.340 | | |
| *8 | −0.46455 | 0.215 | 1.64176 | 22.46 |
| *9 | −0.84982 | 0.045 | | |
| *10 | −2.95471 | 0.468 | 1.54436 | 56.03 |
| *11 | −1.06711 | 0.045 | | |
| *12 | 1.09175 | 0.358 | 1.54436 | 56.03 |
| *13 | 1.00362 | 0.723 | | |
| 14 | ∞ | 0.210 | 1.51633 | 64.14 |
| 15 | ∞ | 0.418 | | |
| 16 (IMG) | ∞ | | | |

*Aspherical Surface

TABLE 22
Example 11 • Aspherical Surface Data

| Si | KA | A3 | A4 | A5 | A6 |
|---|---|---|---|---|---|
| 1 | −1.0324639E+00 | 0.0000000E+00 | 3.2302316E+01 | 9.4872647E+01 | −4.6809799E+00 |
| 2 | −4.2020648E+01 | 0.0000000E+00 | 2.5631574E+01 | 5.1643476E+00 | −2.5775170E+01 |
| 4 | −1.9603239E+01 | 0.0000000E+00 | −2.4976292E+01 | 4.5344098E+00 | −2.3942233E+01 |
| 5 | 6.0696737E+01 | 0.0000000E+00 | −3.4884184E+01 | −8.0406889E+00 | 3.9728040E+01 |
| 6 | 9.9028103E+00 | 0.0000000E+00 | −5.4732424E+01 | −3.3514464E+00 | 1.3894618E+01 |
| 7 | −2.2905773E+00 | 0.0000000E+00 | 1.5697899E+02 | −3.0756909E+01 | −3.9819834E+01 |
| 8 | −1.6585648E+00 | 0.0000000E+00 | −2.0074528E+00 | 1.3860953E+01 | −5.0113103E+01 |
| 9 | −2.9131275E+00 | 0.0000000E+00 | −3.5218394E+01 | 4.9843165E+00 | −1.8027359E+01 |
| 10 | −1.0543183E+01 | 0.0000000E+00 | 5.1221899E+01 | −4.7422212E+00 | 1.3904771E+01 |
| 11 | 2.8486385E+01 | 0.0000000E+00 | −1.6718593E+01 | −2.3660336E+01 | 1.4061918E+00 |
| 12 | 8.7269345E+02 | 0.0000000E+00 | −4.8889977E+01 | 3.6762431E+01 | 1.4189470E+01 |
| 13 | −2.8140493E+00 | 0.0000000E+00 | 3.5987520E+01 | −1.3330674E+00 | 1.9503546E+00 |
| | A7 | A8 | A9 | A10 | |
| 1 | 9.1078921E+00 | −1.0315049E+01 | 6.5775623E+00 | −1.8056546E+00 | |
| 2 | 6.6797230E+01 | −9.6966006E+01 | 6.8732644E+01 | −1.0957101E+01 | |
| 4 | 6.0366409E+01 | −8.1663095E+01 | 5.2087316E+01 | −9.4487232E+00 | |
| 5 | −9.2563712E+01 | 1.1807894E+02 | −7.8843467E+01 | 2.1209413E+01 | |
| 6 | −2.3303361E+01 | 1.7753184E+01 | −3.4389820E+00 | −1.3243438E+00 | |
| 7 | −9.3065289E+02 | 1.6597770E+00 | −1.9312051E+00 | 9.1067898E+01 | |
| 8 | 9.4927788E+01 | −9.6528299E+01 | 5.0967924E+01 | −1.1102589E+01 | |
| 9 | 3.0621666E+01 | −2.7145042E+01 | 1.2162774E+01 | −2.1203893E+00 | |
| 10 | −1.9337851E+01 | 1.4304035E+01 | −5.3812903E+00 | 7.9647252E+01 | |
| 11 | −1.4152405E+00 | 8.0247512E+01 | −3.0929938E+01 | 5.1961297E+02 | |
| 12 | −5.3918842E+01 | 4.3003670E+01 | −1.4558486E+01 | 1.8222180E+02 | |
| 13 | −1.6079518E+00 | 7.7612254E+01 | −2.0371953E+01 | 2.2342698E+02 | |

TABLE 23
Example 12
f = 1.951, Bf = 1.218, Fno. = 2.40, 2ω = 141.0

| Si | Ri | Di | Ndj | νdj |
|---|---|---|---|---|
| *1 | −2.01671 | 0.358 | 1.54436 | 56.03 |
| *2 | 92.06884 | 0.134 | | |
| 3 (St) | ∞ | 0.009 | | |
| *4 | 3.55851 | 0.600 | 1.54436 | 56.03 |
| *5 | −2.26181 | 0.089 | | |
| *6 | 3.09326 | 0.470 | 1.54436 | 56.03 |
| *7 | −2.23734 | 0.298 | | |
| *8 | −0.49073 | 0.215 | 1.64176 | 22.46 |
| *9 | −0.86884 | 0.062 | | |
| *10 | −2.79526 | 0.486 | 1.54436 | 56.03 |
| *11 | −1.03435 | 0.115 | | |
| *12 | 1.25245 | 0.374 | 1.54436 | 56.03 |
| *13 | 1.05036 | 0.723 | | |
| 14 | ∞ | 0.210 | 1.51633 | 64.14 |
| 15 | ∞ | 0.353 | | |
| 16 (IMG) | ∞ | | | |

*Aspherical Surface

TABLE 24
Example 12 • Aspherical Surface Data

| Si | KA | A3 | A4 | A5 | A6 |
|---|---|---|---|---|---|
| 1 | −1.0324639E+00 | 0.0000000E+00 | 3.1429187E+01 | 9.4598881E+01 | −4.6542096E+00 |
| 2 | −4.2020648E+01 | 0.0000000E+00 | 2.5130330E+01 | 5.2214441E+00 | −2.5824914E+01 |
| 4 | −1.9603239E+01 | 0.0000000E+00 | −2.4141187E+01 | 4.5247133E+00 | −2.3970365E+01 |
| 5 | 6.0696737E+01 | 0.0000000E+00 | −3.5082536E+01 | −8.0464161E+00 | 3.9696758E+01 |
| 6 | 9.9028103E+00 | 0.0000000E+00 | −5.3538407E+01 | −3.3547554E+00 | 1.3842289E+01 |
| 7 | −2.2905773E+00 | 0.0000000E+00 | 4.5588244E+02 | −2.9656567E+01 | −4.3636931E+01 |
| 8 | −1.6585648E+00 | 0.0000000E+00 | −1.9873710E+00 | 1.3860281E+01 | −5.0144659E+01 |
| 9 | −2.9131275E+00 | 0.0000000E+00 | −3.6164559E+01 | 4.9871405E+00 | −1.8011270E+01 |
| 10 | −1.0543183E+01 | 0.0000000E+00 | 5.1686200E+01 | −4.7436763E+00 | 1.3905134E+01 |
| 11 | 2.8486385E+01 | 0.0000000E+00 | −1.6787582E+01 | −2.4109860E+01 | 1.4047444E+00 |
| 12 | 8.7269345E+02 | 0.0000000E+00 | −4.4758511E+01 | 3.7016718E+01 | 1.2324472E+01 |
| 13 | −2.8140493E+00 | 0.0000000E+00 | 3.6605309E+01 | −1.3325398E+00 | 1.9508605E+00 |
| | A7 | A8 | A9 | A10 | |
| 1 | 9.1119339E+00 | −1.0352465E+01 | 6.5780923E+00 | −1.7868541E+00 | |
| 2 | 6.6692580E+01 | −9.6890307E+01 | 6.8824394E+01 | −1.0977631E+01 | |
| 4 | 6.0371483E+01 | −8.1658030E+01 | 5.2118785E+01 | −9.4694069E+00 | |
| 5 | −9.2572005E+01 | 1.1815323E+02 | −7.8856274E+01 | 2.1188388E+01 | |
| 6 | −2.3297468E+01 | 1.7830155E+01 | −3.4436184E+00 | −1.3586069E+00 | |
| 7 | −1.0355214E+01 | 1.6761647E+00 | −1.9283040E+00 | 9.0937051E+01 | |
| 8 | 9.4918428E+01 | −9.6485847E+01 | 5.0958985E+01 | −1.1108517E+01 | |
| 9 | 3.0621316E+01 | −2.7159749E+01 | 1.2163907E+01 | −2.1167256E+00 | |
| 10 | −1.9339586E+01 | 1.4301111E+01 | −5.3815325E+00 | 7.9780407E+01 | |
| 11 | −1.4132487E+00 | 8.0424344E+01 | −3.0970839E+01 | 5.1640919E+02 | |
| 12 | −5.3958220E+01 | 4.3391193E+01 | −1.4556656E+01 | 1.7966723E+02 | |
| 13 | −1.6086341E+00 | 7.7558178E+01 | −2.0359650E+01 | 2.2403133E+02 | |

TABLE 25
Values of Conditional Expressions

| Expression | | | | | | | |
|---|---|---|---|---|---|---|---|
| No. | Conditional Expression | Example 1 | Example 2 | Example 3 | Example 4 | Example 5 | Example 6 |
| 1 | TTL/f | 1.957 | 1.799 | 2.094 | 2.034 | 1.973 | 2.028 |
| 2 | f/f1 | −0.445 | −0.552 | −0.091 | −0.858 | −0.706 | −0.821 |
| 3 | f/f2 | 0.844 | 1.718 | 1.264 | 1.730 | 1.750 | 1.667 |
| 4 | f/f3 | 0.609 | −0.403 | −0.187 | −0.242 | −0.414 | −0.096 |
| 5 | f/f4 | −1.110 | −0.595 | −0.880 | −0.508 | −0.383 | −0.810 |
| 6 | f/f5 | 1.037 | 0.737 | 0.647 | 0.841 | 0.666 | 0.891 |
| 7 | f/L6r | 2.756 | 3.454 | 2.585 | 2.862 | 2.855 | 3.064 |
| 8 | (L4r + L4f)/(L4r − L4f) | 2.685 | 3.482 | 2.811 | 4.798 | 5.456 | 3.261 |
| Expression | | | | | Example | Example | Example |
| No. | Conditional Expression | Example 7 | Example 8 | Example 9 | 10 | 11 | 12 |
| 1 | TTL/f | 2.109 | 2.081 | 1.977 | 2.118 | 2.260 | 2.269 |
| 2 | f/f1 | −0.697 | −0.662 | −0.561 | −0.357 | −0.583 | −0.539 |
| 3 | f/f2 | 1.760 | 1.665 | 0.958 | 0.772 | 0.769 | 0.740 |
| 4 | f/f3 | −0.188 | −0.113 | 0.586 | 0.614 | 0.792 | 0.793 |
| 5 | f/f4 | −1.129 | −1.134 | −1.050 | −1.135 | −0.957 | −0.864 |
| 6 | f/f5 | 0.449 | 0.417 | 1.009 | 0.746 | 0.692 | 0.710 |
| 7 | f/L6r | 2.600 | 2.543 | 2.677 | 1.948 | 1.947 | 1.858 |
| 8 | (L4r + L4f)/(L4r − L4f) | 1.842 | 2.311 | 1.847 | 2.833 | 3.412 | 3.596 |

The paraxial radius of curvature, surface distance, refractive index, and Abbe number described above were obtained by an optical measurement expert through measurement by the following method.

The paraxial radius of curvature was obtained in the following steps by measuring the lens using an ultra-accuracy 3-D profilometer, UA3P (product of Panasonic Factory Solutions Corporation). A paraxial radius of curvature Rₘ (m is a natural number) and a cone constant Kₘ are tentatively set and inputted to the UA3P and an n^{th} order aspherical surface coefficient An of the aspherical surface shape formula is calculated from these and measurement data using an auxiliary fitting function of the UA3P. It is assumed, in the aspherical surface shape formula (A), that C=1/Rₘ and KA=Kₘ−1. From Rₘ, Kₘ, An, and the aspherical surface shape formula, a depth Z of the aspherical surface in an optical axis direction according to the height h from the optical axis is calculated. A difference between a calculated depth Z and a measured depth Z′ is obtained at each height h from the optical axis, then a determination is made whether or not the difference is within a predetermined range, and if the difference is within the predetermined range, the set Rₘ is taken as the paraxial radius of curvature. On the other hand, if the difference is outside of the predetermined range, at least one of the values of Rₘ and Kₘ used in the calculation of the difference is set to Rₘ₊₁ and Kₘ₊₁ and inputted to the UA3P, then processing identical to that described above is performed, and determination processing whether or not a difference between a calculated depth Z and a measured depth Z′ at each height h from the optical axis is within the predetermined range is repeated until the difference between the calculated depth Z and the measured depth Z′ at each height h from the optical axis remains within the predetermined range. The term, within a predetermined range, as used herein refers to within 200 nm. The range of h is a range corresponding to 0 to ⅕ of the maximum outer diameter.

The surface distance was obtained by performing measurement using a thickness and distance measuring device for coupling lenses, OptiSurf (product of Trioptics).

The refractive index was obtained by measuring a test object with the temperature of the test object being maintained at 25° C. using a precision refractometer, KPR-2000 (product of Shimadzu Corporation). The refractive index measured at the d-line (wavelength 587.6 nm) is taken as Nd. Likewise, the refractive indices measured at the e-line (wavelength 546.1 nm), the F-line (wavelength 486.1 nm), the C-line (wavelength 656.3 nm) and the g-line (wavelength 435.8 nm) are taken as Ne, NF, NC, and Ng respectively. The Abbe number vd with respect to the d-line was obtained by substituting the Nd, NF, and NC obtained by the aforementioned measurements in a formula, vd=(Nd−1)/(NF−NC).

What is claimed is:

1. An imaging lens, consisting of six lenses, composed of, in order from the object side:
a first lens having a negative refractive power with a concave surface on the object side;
a second lens having a positive refractive power;
a third lens;
a fourth lens having a meniscus shape with a concave surface on the object side;
a fifth lens having a meniscus shape with a concave surface on the object side; and
a sixth lens having a meniscus shape with a convex surface on the object side.

2. The imaging lens of claim 1, wherein the following conditional expression is further satisfied:
TTL/f<3 (1)
where:
TTL is the distance from the object side surface of the first lens to the image plane on the optical axis when an air equivalent length is used for the back focus; and
f is the focal length of the entire system.

3. The imaging lens of claim 1, wherein the second lens has a biconvex shape.

4. The imaging lens of claim 1, wherein the fourth lens has a negative refractive power.

5. The imaging lens of claim 1, wherein the fifth lens has a positive refractive power.

6. The imaging lens of claim 1, wherein the following conditional expression is further satisfied:
−2<f/f1<0 (2)
where:
f is the focal length of the entire system; and
f1 is the focal length of the first lens.

7. The imaging lens of claim 1, wherein the following conditional expression is further satisfied:
0<f/f2<3 (3)
where:
f is the focal length of the entire system; and
f2 is the focal length of the second lens.

8. The imaging lens of claim 1, wherein the following conditional expression is further satisfied:
−0.95<f/f3<0.95 (4)
where:
f is the focal length of the entire system; and
f3 is the focal length of the third lens.

9. The imaging lens of claim 1, wherein the following conditional expression is further satisfied:
−2<f/f4<0 (5)
where:
f is the focal length of the entire system; and
f4 is the focal length of the fourth lens.

10. The imaging lens of claim 1, wherein the following conditional expression is further satisfied:
0<f/f5<2 (6)
where:
f is the focal length of the entire system; and
f5 is the focal length of the fifth lens.

11. The imaging lens of claim 1, wherein the following conditional expression is further satisfied:
1<f/L6r<4 (7)
where:
f is the focal length of the entire system; and
L6r is the paraxial radius of curvature of the image side surface of the sixth lens.

12. The imaging lens of claim 1, wherein the following conditional expression is further satisfied:
1<(L4r+L4f)/(L4r−L4f)<10 (8)
where:
L4f is the paraxial radius of curvature of the object side surface of the fourth lens; and
L4r is the paraxial radius of curvature of the image side surface of the fourth lens.

13. The imaging lens of claim 2, wherein the following conditional expression is further satisfied:
TTL/f<2.5 (1-1)
where:
TTL is the distance from the object side surface of the first lens to the image plane on the optical axis when an air equivalent length is used for the back focus; and
f is the focal length of the entire system.

14. The imaging lens of claim 6, wherein the following conditional expression is further satisfied:
−1.5<f/f1<−0.05 (2-1)
where:
f is the focal length of the entire system; and
f1 is the focal length of the first lens.

15. The imaging lens of claim 7, wherein the following conditional expression is further satisfied:
0.5<f/f2<2.5 (3-1)
where:
f is the focal length of the entire system; and
f2 is the focal length of the second lens.

16. The imaging lens of claim 8, wherein the following conditional expression is further satisfied:
−0.85<f/f3<0.85 (4-1)
where:
f is the focal length of the entire system; and
f3 is the focal length of the third lens.

17. The imaging lens of claim 9, wherein the following conditional expression is further satisfied:
−1.5<f/f4<0 (5-1)
where:
f is the focal length of the entire system; and
f4 is the focal length of the fourth lens.

18. The imaging lens of claim 10, wherein the following conditional expression is further satisfied:
0<f/f5<1.5 (6-1)
where:
f is the focal length of the entire system; and
f5 is the focal length of the fifth lens.

19. The imaging lens of claim 11, wherein the following conditional expression is further satisfied:
1<f/L6r<3.5 (7-1)
where:
f is the focal length of the entire system; and
L6r is the paraxial radius of curvature of the image side surface of the sixth lens.

20. An imaging apparatus equipped with the imaging lens of claim 1.
